(19) United States
(12) Patent Application Publication
(10) Pub. No.: US 2024/0419004 A1
(43) Pub. Date: Dec. 19, 2024

(54) PROJECTOR MODULE AND RETINAL PROJECTION DISPLAY DEVICE COMPRISING SAME

(71) Applicant: TDK CORPORATION, Tokyo (JP)

(72) Inventor: Takashi ASATANI, Tokyo (JP)

(73) Assignee: TDK CORPORATION, Tokyo (JP)

(21) Appl. No.: 18/714,773

(22) PCT Filed: Mar. 28, 2022
(86) PCT No.: PCT/JP2022/014877

§ 371 Date: May 30, 2024

(51) Int. Cl. G02B 27/01; G02B 26/08; G02B 26/10

(52) U.S. Cl. CPC G02B 27/0176; G02B 26/0833; G02B 26/101; G02B 27/0179; G02B 2027/0154; G02B 2027/0187

(57) ABSTRACT

A projector module that is able to be used in a retinal projection display device and moved by a movement means includes a laser module having a plurality of laser chips, a collimation lens configured to convert light from the laser module into parallel light beams, and an optical scanning device configured to change a direction of the light from the collimation lens to perform a scanning process. Relative positions of the laser module, the collimation lens, and the optical scanning device are fixed.

### TECHNICAL FIELD

The present invention relates to a projector module and a retinal projection display device comprising the same.

### BACKGROUND ART

AR (Augmented Reality) glasses and VR (Virtual Reality) glasses are expected to be small wearable image display devices. In these devices, a light-emitting module configured to emit full-color visible light is one major element for drawing high-quality images. In these devices, the light-emitting module independently modulates the intensity of each of three RGB colors representing, for example, visible light, at a high speed, and represents an image with a desired color.

As a modulation method for the light intensity of the three RGB colors in such a light-emitting module, a method of outputting a color image by controlling an output intensity of a laser chip of each color with an electric current is disclosed in Patent Document 1. Moreover, in Patent Document 2 of the citation list, a method of guiding laser light to a modulator having a waveguide formed on a substrate having an electro-optic effect through an optical fiber and independently modulating the intensity of each of the three RGB colors with the modulator is disclosed.

In wearable image display devices such as AR glasses and VR glasses, the key to widespread use is that the light-emitting module is miniaturized so that each function fits within the size of regular eyeglasses.

### CITATION LIST

### Patent Document

### [Patent Document 1]

Japanese Unexamined Patent Application, First Publication No. 2021-86976

### [Patent Document 2]

Japanese Patent No. 6728596

### [Patent Document 3]

Japanese Unexamined Patent Application, First Publication No. 2009-130988

### [Patent Document 4]

Japanese Patent No. 2012-170270

### SUMMARY OF INVENTION

### Technical Problem

Although a laser output intensity is directly controlled by an electric current in a light-emitting element disclosed in Patent Document 1 of the citation list, it is necessary to control an electric current on the basis of an electric current value greater than a threshold current by a certain level or more so that the stability of the output intensity is ensured. Therefore, there is a problem that power consumption is large and difficult to reduce.

Moreover, in Patent Document 2 of the citation list, an optical modulator in which a substrate made of lithium niobate, lithium tantalate, lead lanthanum zirconate titanate, potassium titanate phosphate, polythiophene, liquid crystal materials, or various types of induced polymers having an electro-optic effect is used and an optical waveguide is provided on the substrate is disclosed. Among these, an aspect in which a single crystal or solid solution crystal of lithium niobate is particularly used and a portion thereof is modified in a proton exchange method or a Ti diffusion method to form an optical waveguide is disclosed as a preferred aspect. However, it is difficult to reduce the diameter of the optical waveguide because the size of the modified waveguide portion (core) region is determined according to a penetration or diffusion distance of protons or Ti. Therefore, the size of the optical waveguide itself has to be large, and the large diameter of the optical waveguide makes it difficult for an electric field of a modulation voltage to concentrate, so it is necessary to apply a large voltage for modulation. However, in order to perform an operation with a small voltage, it is necessary to lengthen an electrode to which the voltage is applied, resulting in an increase in the size of an element.

Moreover, as shown in FIG. 22(a), in a modulator in which a partially modified portion B1-a of a single crystal B1 of bulk lithium niobate is used as an optical waveguide, because a refractive index difference Δn is simply created by adding a small amount of Ti to a bulk lithium niobate single crystal, the refractive index difference between the modified waveguide portion (core) and the unmodified portion (cladding) is small. Therefore, because the bending loss caused by curvature of the optical waveguide is large and the optical waveguide cannot be bent with high curvature, it is difficult to reduce the size of the element. Although the modulated light source mounted on a head-mounted display such as AR glasses is required to have a size that fits within the size of, for example, the frame of eyeglasses, it is difficult to produce an optical modulator miniaturized to such a size in a bulk-crystal-type optical modulator as shown in Patent Document 2 of the citation list.

In the case of a modulator in which a convex portion Fridge formed by processing a single crystal lithium oxide film F epitaxially grown on a substrate of sapphire or the like as shown in FIG. 22(b) is used as an optical waveguide as compared with a modulator in which a partially modified portion B1-a of a lithium niobate single crystal B1 is used as an optical waveguide, it is appropriate for size reduction because the size of the convex portion is small as compared with a Ti diffusion optical waveguide, the refractive index difference Δn can be increased by appropriately selecting the surrounding materials due to all the surroundings of the convex portion corresponding to the cladding, and the optical loss when the optical waveguide is bent in a curved shape is small as compared with a bulk lithium niobate single crystal.

Moreover, in FIG. 7 of Patent Document 2 of the citation list, an optical module 100 in which a light source unit 311 and a modulator 30 are modularized as a constituent unit and the light source unit 311 is not caused to directly perform a modulation process and light externally modulated by the modulator 30 can be output is disclosed. When an optical module having a configuration in which red (R), green (G), and blue (G) laser beams are output from the modulator 30 and then multiplexed like the optical module 100 disclosed in Patent Document 2 of the citation list is used as a constituent element of an optical engine, the optical system becomes large as will be described below, and therefore it is difficult to reduce the size of the optical engine.

In FIG. 23(a), a transmission type method is shown as a representative image display method in an image display device.

In this method, a video is projected onto a transmissive half-mirror and an observer recognizes a displayed image by looking at a virtual screen at the end of the half-mirror.

On the other hand, in a retinal projection method shown in FIG. 23(b), a displayed image is recognized by directly projecting a video onto a retina. Because a video projected from the light source can be superimposed on the scenery seen with the naked eye, AR display is possible. In this method, because the light from the light source is temporarily caused to converge on the pupil and then projected onto the retina, the image is formed on the retina regardless of the thickness of the lens. This type of vision is referred to as Maxwell's vision and enables a deep depth of field because an adjustment function of the lens of the eyeball is not used. In other words, there is an advantage that the projected video can be seen without blurring while focusing on the background. On the other hand, there is a problem that when the pupil moves, the light is disrupted (occurrence of “vignetting”), the displayed image is easily obscured, and an eye box (a range where the center of the pupil can move) is narrow.

The present invention has been made in view of the above-described problems and an objective of the present invention is to provide a small retinal projection display device capable of being mounted on AR glasses, VR glasses, or the like and having a wide angle of view at which pupil vignetting due to a change in a pupil position is suppressed and a projector module for use therein.

### Solution to Problem

The present invention provides the following means to achieve the above-described objective.

According to a first aspect of the present invention, there is provided a projector module that is able to be used in a retinal projection display device and moved by a movement means, the projector module including: a laser module having a plurality of laser chips; a collimation lens configured to convert light from the laser module into parallel light beams; and an optical scanning device configured to change a direction of the light from the collimation lens to perform a scanning process, wherein relative positions of the laser module, the collimation lens, and the optical scanning device are fixed.

In the projector module according to the above-described aspect, the laser module may include a planer lightwave circuit configured to multiplex light output from the plurality of laser chips, the light output from the plurality of laser chips may be modulated with a driving current, the collimation lens may collimate the light multiplexed by the planer lightwave circuit, the optical scanning device may perform the scanning process with the collimated light.

In the projector module according to the above-described aspect, the laser module may include a plurality of Mach-Zehnder-type optical waveguides configured to guide the light output from the plurality of laser chips and a multiplexing portion configured to multiplex modulated light from the plurality of Mach-Zehnder-type optical waveguides, the collimation lens may collimate the light multiplexed by the multiplexing portion, and the optical scanning device may change a direction of the collimated light to perform the scanning process.

In the projector module according to the above-described aspect, a plurality of collimation lenses configured to convert light of each of the plurality of laser chips into parallel light beams may be provided as the collimation lens, the number of collimation lenses being the same as the number of laser chips, the projector module may include a dichroic mirror configured to multiplex the light collimated by the plurality of collimation lenses, and the optical scanning device may change a direction of light multiplexed by the dichroic mirror to perform the scanning process.

In the projector module according to the above-described aspect, a plurality of collimation lenses configured to convert light from each of the plurality of laser chips into parallel light beams may be provided as the collimation lens, the number of collimation lenses being the same as the number of laser chips, the light collimated by the plurality of collimation lenses may be input to the optical scanning device at different angles, and the optical scanning device may change a direction of light to perform the scanning process.

In the projector module according to the above-described aspect, the Mach-Zehnder-type optical waveguide may be made by convexly processing a lithium niobate film.

In the projector module according to the above-described aspect, the optical scanning device may be a microelectromechanical systems (MEMS) mirror device.

According to a second aspect of the present invention, there is provided a retinal projection display device including: the projector module according to the above-described aspect; a movement means configured to move the projector module; and a pupil position detection means configured to detect a pupil position, wherein the movement means moves the projector module in correspondence with a change in the pupil position detected by the pupil position detection means.

In the retinal projection display device according to the above-described aspect, the movement means may be a two-dimensional stage using a linear actuator.

In the retinal projection display device according to the above-described aspect, the linear actuator may be a piezoelectric ultrasonic linear motor.

In the retinal projection display device according to the above-described aspect, the movement means may be an actuator using a spherical motor.

In the retinal projection display device according to the above-described aspect, the movement means may be a voice coil motor.

In the retinal projection display device according to the above-described aspect, a gap between magnetic circuits sandwiching a coil may be filled with a magnetic fluid in the voice coil motor.

The retinal projection display device according to the above-described aspect may include an optical system of a Kepler-type telescope configuration in which an intermediate imaging plane is located between the optical scanning device and the pupil.

In the retinal projection display device according to the above-described aspect, a focal length of a concave surface mirror of a pupil side of an optical path of the optical system of the Kepler-type telescope configuration or a diffraction element having a function similar to that of a convex lens or a concave surface mirror may be longer than a focal length of a concave surface mirror on the projector module side or a diffraction element having a function similar to that of a convex lens or a concave surface mirror.

The retinal projection display device according to the above-described aspect may include a field lens configured to adjust a light beam direction in the vicinity of the intermediate imaging plane.

The retinal projection display device according to the above-described aspect may include a light guide plate between an optical system of the Kepler-type telescope configuration and a pupil, wherein an image may be projected onto a retina through the light guide plate.

The retinal projection display device according to the above-described aspect may include a refraction element at a position of an input from the optical system of the Kepler-type telescope configuration of the light guide plate; and another refraction element at a position of an output from the light guide plate to the pupil.

The retinal projection display device according to the above-described aspect may include an input prism at a position of an input from the optical system of the Kepler-type telescope configuration of the light guide plate; and a translucent mirror at a position of an output from the light guide plate to the pupil.

The retinal projection display device according to the above-described aspect may include an input prism at a position of an input from the optical system of the Kepler-type telescope configuration of the light guide plate; and a refraction element at a position of an output from the light guide plate to the pupil.

According to a third aspect of the present invention, there is provided a head-up display including: the retinal projection display device according to the above-described aspect for use in each of left and right eyes, wherein the movement means moves the projector module in correspondence with a change in a pupil position of the left or right eye detected by the pupil position detection means in correspondence with the pupil position of the left or right eye detected using the pupil position detection means.

In the head-up display according to the above-described aspect, the collimation lens of the projector module may be a variable lens or a distance between the collimation lens and the laser module in the projector module may be variable.

In the head-up display according to the above-described aspect, the head-up display may be for automotive use.

### Advantageous Effects of Invention

According to the present invention, it is possible to provide a small retinal projection display device capable of being mounted on AR glasses, VR glasses, or the like and having a wide angle of view at which pupil vignetting due to a change in a pupil position is suppressed.

### BRIEF DESCRIPTION OF DRAWINGS

FIG. 1 is a schematic diagram of AR glasses as an example of a retinal projection display device according to the present embodiment.

FIG. 2 is a diagram for describing the technical significance of an optical system of a Kepler-type telescope configuration.

FIG. 3 is a diagram for describing the technical significance of the optical system of the Kepler-type telescope configuration.

FIG. 4 is a view schematically showing an example of a projector module according to a first embodiment, where (a) is a top view, (b) is a side view seen in a Y-direction, and (c) is a side view seen in an X-direction.

FIG. 5 is a modified example of the projector module according to the first embodiment, where (a) is a first modified example and (b) is a second modified example.

FIG. 6 is a schematic top view of an example of an electromagnetic drive MEMS mirror device.

FIG. 7(a) is a schematic perspective view of a general motor, FIG. 7(b) is a schematic perspective view of a spherical motor, and FIG. 7(c) is a schematic perspective view of a magnetostrictive spherical motor.

FIG. 8A is a schematic top view of an example of a laser module.

FIG. 8B is a schematic top view of another example of the laser module.

FIG. 9 is a schematic cross-sectional view cut along line X-X in FIG. 8B.

FIG. 10 is a schematic cross-sectional view cut along line Y-Y in FIG. 8B.

FIG. 11 is a block diagram of an optical modulation/output portion 200.

FIG. 12 is a diagram showing an optical modulation curve in each Mach-Zehnder-type optical waveguide.

FIG. 13 is a diagram schematically showing (a) an MMI-type wave multiplexer, (b) a Y-shaped wave multiplexer, and (c) a directional coupler.

FIG. 14 is a first configuration example for approximating a light output ratio of colors to 1:1:1.

FIG. 15 is a second configuration example for approximating a light output ratio of colors to 1:1:1.

FIG. 16 is a third configuration example for approximating a light output ratio of colors to 1:1:1.

FIG. 17 is a schematic top view of a Mach-Zehnder-type optical waveguide having a bent portion.

FIG. 18 is a schematic diagram for describing a process of moving the projector module in accordance with a change in a pupil position using a linear actuator as a movement means of the projector module and causing a light beam from the projector module to pass through a pupil.

FIG. 19 is a schematic diagram for describing a process of moving the projector module in accordance with a change in a pupil position using an actuator with a spherical motor as the movement means of the projector module and causing a light beam from the projector module to pass through a pupil.

FIG. 20 is a schematic diagram of AR glasses as another example of the retinal projection display device according to the present embodiment.

FIG. 21 is a schematic diagram showing an example of a head-up display.

FIG. 22(a) is a conceptual diagram for describing a modulator in which a partially modified portion of a single crystal of bulk lithium niobate is an optical waveguide and FIG. 22(b) is a conceptual diagram for describing a modulator in which a convex portion formed by processing a single crystal lithium niobate film is an optical waveguide.

FIG. 23 shows (a) a transmission type method and (b) a retinal projection method as a typical image display method in the image display device.

### DESCRIPTION OF EMBODIMENTS

Hereinafter, embodiments will be described in detail with reference to the drawings as appropriate. In the drawings used in the following description, featured parts may be enlarged for convenience such that the features of the present invention are easier to understand, and dimensional ratios and the like of the respective constituent elements may be different from actual ones. Materials, dimensions, and the like exemplified in the following description are examples, the present invention is not limited thereto, and modifications can be appropriately made in a range in which advantageous effects of the present invention are exhibited.

### [Retinal Projection Display Device]

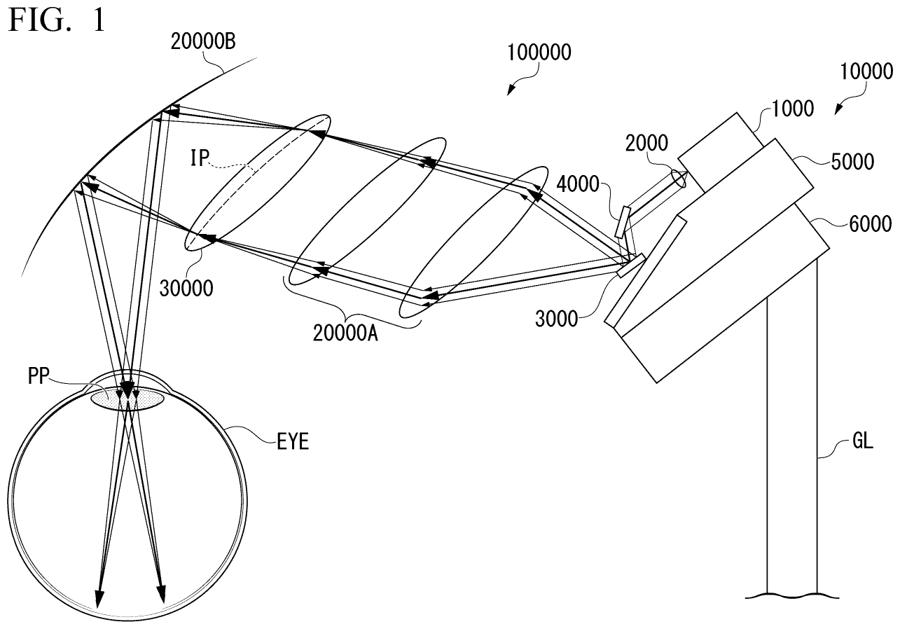

FIG. 1 shows a schematic diagram of AR glasses as an example of a retinal projection display device according to the present embodiment. In FIG. 1, featured parts are shown enlarged such that the features of the present invention are easier to understand.

A retinal projection display device 100000 shown in FIG. 1 includes a projector module 10000, a movement means 6000 configured to move the projector module 10000, and a pupil position detection means (not shown) for detecting a pupil position, whereby the movement means 6000 can move the projector module 10000 in correspondence with a change in the pupil position detected by the pupil position detection means. Reference sign GL denotes a glasses frame.

The retinal projection display device according to the present invention can implement a retinal projection display having a wide angle of view for preventing pupil vignetting due to a change in the pupil position when the movement means 6000 moves the projector module 10000.

The projector module 10000 includes a laser module 1000 having a plurality of laser chips, a collimation lens 2000 configured to convert light from the laser module 1000 into parallel light beams, and an optical scanning device 3000 configured to change a direction of the light from the laser module 1000 to perform a scanning process. Relative positions of the laser module 1000, the collimation lens 2000, and the optical scanning device 3000 are fixed.

The pupil position detection means (not shown) for detecting the pupil position can use known technology. For example, it is possible to use a method of detecting a position of a pupil PP in an eyeball EYE by imaging the eyeball EYE with a camera, a method of detecting a position of the pupil PP in the eyeball EYE by irradiating the eyeball EYE with light and using the reflected light from the eyeball EYE, or the like.

The AR glasses 100000 shown in FIG. 1 further include optical systems 20000A and 20000B in a Kepler-type telescope configuration in which an intermediate imaging plane IP is located between the optical scanning device 3000 and the pupil.

The optical system of a telescope basically includes a combination of two lenses (an objective lens and an eyepiece lens) and a Kepler-type telescope is one in which both the objective lens and the eyepiece lens are convex lenses. Here, reference sign 20000A corresponds to the objective lens and reference sign 20000B corresponds to the eyepiece lens. Reference sign 20000B denotes a concave surface mirror, which has a function similar to that of a convex lens. The concave surface mirror 20000B is a translucent (half-mirror) combiner for superimposing the scenery seen by the observer and an image (video) from the projector module 1000 and displaying a superimposition result. The observer sees a remotely enlarged and displayed image through the combiner 20000B. The stroke of the actuator can be reduced by shortening a focal length of the objective lens 20000A as compared with a focal length of the eyepiece lens 20000B.

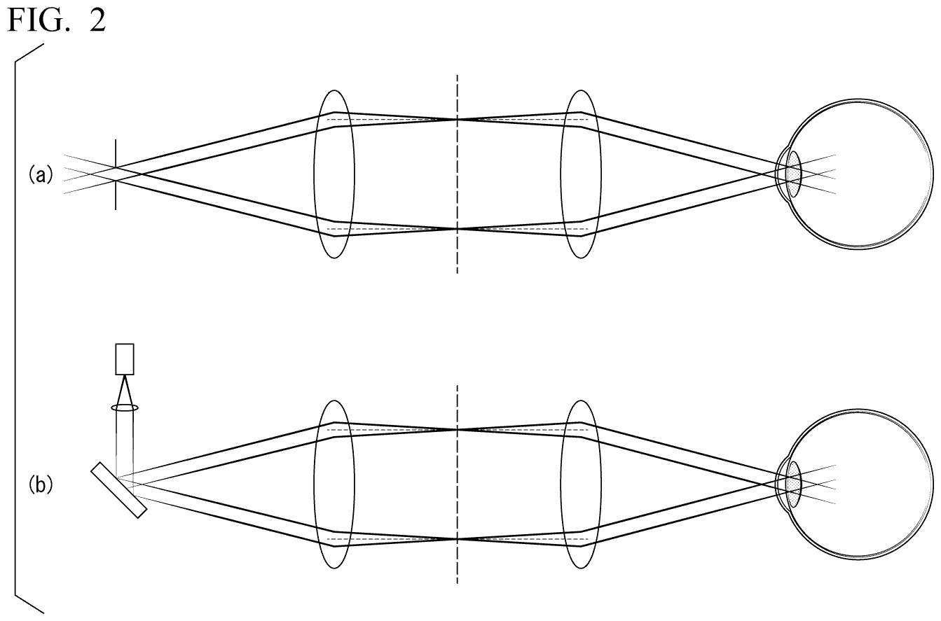

The technical significance of the optical system of the Kepler-type telescope configuration will be described with reference to FIG. 2.

From FIGS. 2(a) and 2(b), it can be seen that an aperture diaphragm and a MEMS mirror are equivalent in the optical system of the Kepler-type telescope configuration. If only the center of each beam is tracked, the beam diverging from a position of the aperture diaphragm will form an image in the center of the pupil. Because the light emitted from the position plane of the aperture diaphragm forms an image in the plane of the pupil position, this optical system can be seen as an optical system such as a semiconductor lithography device (stepper). Then, it can be seen that there is a MEMS mirror position corresponding to any pupil position. Therefore, it can be seen that the MEMS mirror can be moved in correspondence with the movement of the pupil.

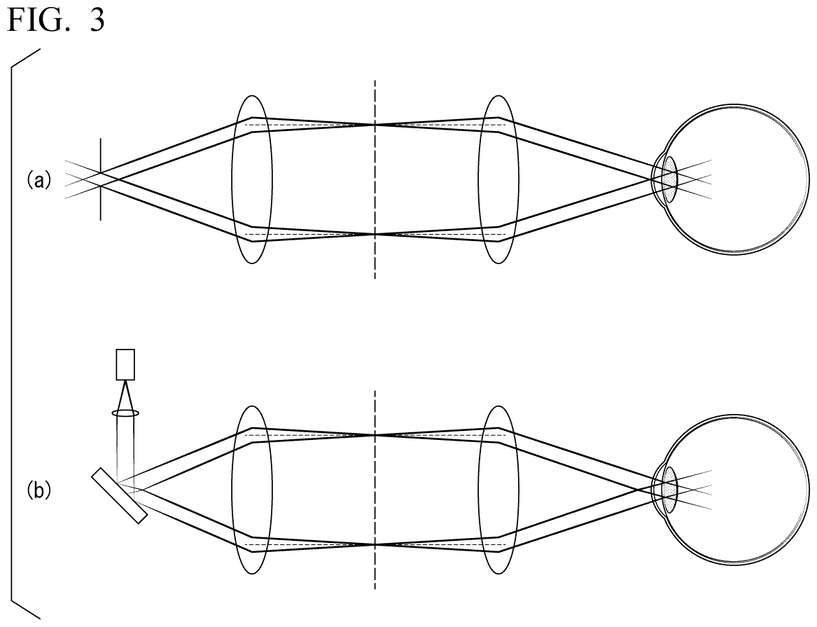

FIG. 2 shows the arrangement of the optical system in the Kepler-type telescope configuration when the magnification is equal magnification (1×), but FIG. 3 shows the optical system of the Kepler-type telescope configuration in the case of non-equal magnification. FIG. 3 is a case of 0.5 times.

An input beam diameter is doubled at the output side. The displacement of a viewpoint position on the pupil side is twice the displacement of the aperture diaphragm (MEMS mirror position) on the input side in a lateral direction (a direction perpendicular to an optical axis). The displacement of the viewpoint position on the pupil side is 4 (=2\hat{ }2) times the displacement of the aperture diaphragm (MEMS mirror position) on the input side in a longitudinal direction (optical axis direction).

In the retinal projection display device according to the present invention, even if the projector module is moved according to the movement of the pupil position, it is possible to radiate a light beam to the pupil position without side effects such as a change in focus by employing a Kepler-type telescope optical system.

In the retinal projection display device 100000 shown in FIG. 1, a field lens 30000 configured to adjust the light beam direction in the vicinity of the intermediate imaging plane is further provided.

### Projector Module (First Embodiment)

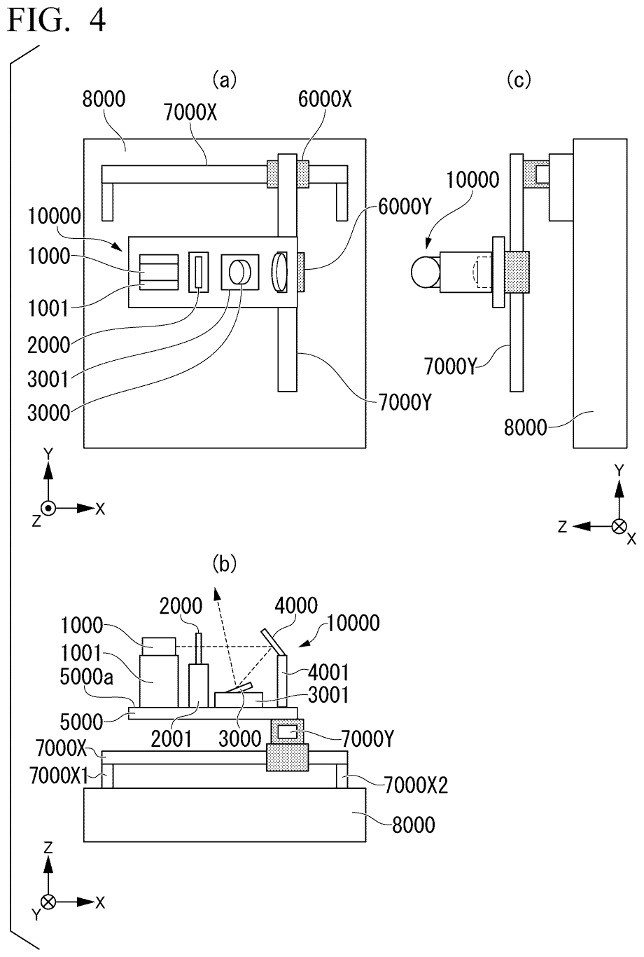

FIG. 4 is a view schematically showing an example of a projector module according to a first embodiment, where (a) is a top view, (b) is a side view seen in a Y-direction, and (c) is a side view seen in an X-direction.

The projector module 10000 shown in FIG. 4 is a projector module, which is able to be used in a retinal projection display device and moved by a movement means, includes the laser module 1000 having a plurality of laser chips, the collimation lens 2000 configured to convert light from the laser module 1000 into parallel light beams, and the optical scanning device 3000 configured to change a direction of the light from the collimation lens 2000 to perform a scanning process. Relative positions of the laser module 1000, the collimation lens 2000, and the optical scanning device 3000 are fixed.

The projector module according to the first embodiment can include other optical systems in addition to the laser module, the collimation lens, and the optical scanning device. The projector module 10000 shown in FIG. 4 further includes a reflection mirror 4000 configured to reflect light collimated by the collimation lens 2000 to the optical scanning device 3000.

The laser module 1000 is fixed to a fixation stage 5000 via the support member 1001, the collimation lens 2000 is fixed to the fixation stage 5000 via the support member 2001, and the optical scanning device 3000 is fixed to the fixation stage 5000 via the support member 3001. Thus, because the laser module 1000, the collimation lens 2000, and the optical scanning device 3000 are fixed to the fixation plate 5000, their relative positions are uniform. Accordingly, when the projector module is moved so that the light beam from the projection module can pass through the pupil in accordance with a change in the pupil position, relative positions of the laser module 1000, the collimation lens 2000, and the optical scanning device 3000 are fixed.

The fixation plate 5000 is preferably made of a high-thermal-conductivity material. This is because the heat generated by the projector module can be efficiently dissipated. Examples of the high-thermal-conductivity material can include copper-based materials, aluminum materials, SUS, ceramic substrates having high-thermal-conductivity such as aluminum nitride and silicon nitride, and the like.

In FIG. 4, a linear actuator 6000X as a movement means for moving the projector module 10000 in the X-direction and a linear actuator 6000Y as a movement means for moving the projector module 10000 in the Y-direction are shown. If the linear actuator 6000X is driven, the projector module 10000 can move in the X-direction along a guide rail 7000X. Moreover, if the linear actuator 6000Y is driven, the projector module 10000 can move in the Y-direction along a guide rail 7000Y. The fixation stage 5000 is a two-dimensional stage that can move in the X-direction and the Y-direction using the linear actuator 6000X and the linear actuator 6000Y.

A known linear actuator can be used. For example, a piezoelectric ultrasonic linear motor can be used. Piezoelectric ultrasonic linear motors are friction drive motors that rub and move rotors and sliders with ultrasonic vibrations excited by piezoelectric elements. The response speed is fast because a piezoelectric element is used and it is a quiet motor that does not generate noise because there is no reducer.

The guide rail 7000X is fixed to a fixation base 8000 via the support member 7000X1 and the support member 7000X2.

The fixation base 8000 is preferably made of a high-thermal-conductivity material. This is because the generated heat can be efficiently dissipated. Examples of the high-thermal-conductivity material can include copper-based materials, aluminum materials, SUS, ceramic substrates having high thermal conductivity such as aluminum nitride and silicon nitride, and the like.

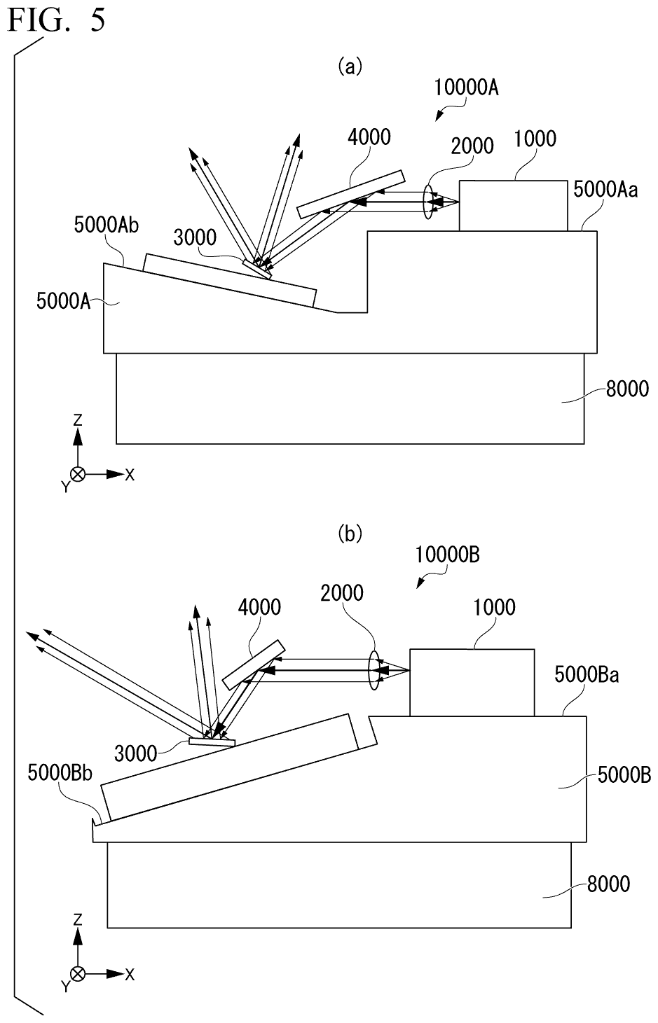

Although the laser module 1000, the collimation lens 2000, and the optical scanning device 3000, which are the constituent elements, are all arranged on the horizontal surface 5000a of the fixation stage 5000 in the projector module shown in FIG. 4, a configuration in which they are arranged on a fixation stage having surfaces with different heights and angles may be adopted as shown in FIGS. 5(a) and 5(b). Also, in FIG. 4, a part of the illustration of the support member for supporting the constituent element and the movement means is omitted. Because constituent elements having the same reference signs are assumed to have similar configurations, description thereof will be omitted.

In the projector module 10000A shown in FIG. 5(a), the fixation stage 5000A has a horizontal plane 5000Aa in which the laser module 1000, the collimation lens 2000, and the reflection mirror 4000 are arranged on a surface of the same height via a support member or without the support member, and an inclined surface 5000Ab on which the optical scanning device 3000 is arranged via the support member, wherein the inclined surface 5000Ab is a surface inclined toward the horizontal surface 5000Aa side at a height lower than that of the horizontal surface 5000Aa. An inclination angle of the inclined surface shown in FIG. 5(a) is about 20°, but the inclination angle can be appropriately set according to the configuration of the projector module or the configuration of the retinal projection display device in which the projector module is incorporated.

In the projector module 10000B shown in FIG. 5(b), the fixation stage 5000B has a horizontal plane 5000Ba in which the laser module 1000, the collimation lens 2000, and the reflection mirror 4000 are arranged on a surface of the same height via a support member or without the support member and an inclined surface 5000Bb on which the optical scanning device 3000 is arranged via the support member, wherein the inclined surface 5000Bb is a surface inclined toward the side away from the horizontal surface 5000Ab at a height lower than that of the horizontal surface 5000Ab. The inclination angle of the inclined surface shown in FIG. 5(b) is about 30°, but the inclination angle can be appropriately set in accordance with the configuration of the projector module or the configuration of the retinal projection display device in which the projector module is incorporated.

### (Optical Scanning Device)

Although a known means capable of reflecting input light to perform a scanning process can be used as the optical scanning device 3000, it is preferably a MEMS mirror. This is because the MEMS mirror device has advantages such as a large mirror deflection angle and low power consumption.

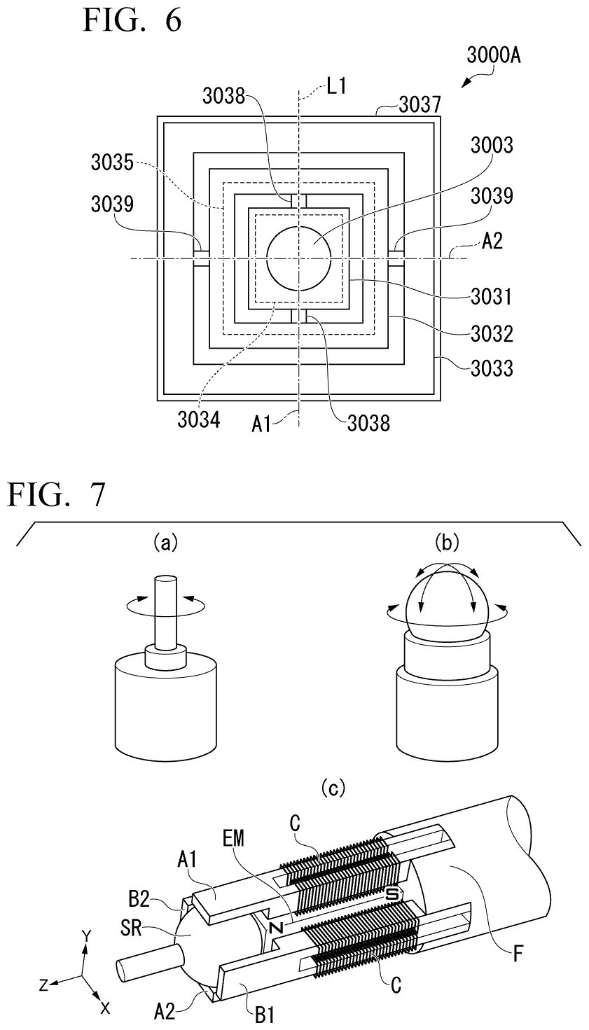

FIG. 6 shows a schematic top view of an example of an electromagnetically driven MEMS mirror device.

A MEMS mirror device 3000A has a mirror 3003 configured to reflect input laser light L1. The MEMS mirror device 3000A is a drive mirror manufactured with micro electro mechanical systems (MEMS) technology. The MEMS mirror device 3000A performs a scanning process with the laser light L1 by oscillating the mirror 3003 with each of the first and second axes perpendicular to each other as the center line.

The MEMS mirror device 3000A shown in FIG. 6 includes a first movable portion 3031, a second movable portion 3032, a support portion 3033, a first drive coil 3034, a second drive coil 3035, and a magnet 3037 in addition to the mirror 3003. The mirror 3003 is provided on the first movable portion 3031. The second movable portion 3032 supports the first movable portion 3031 so that it can be oscillated with the first axis A1 as the center line. The support portion 3033 supports the second movable portion 3032 so that it can be oscillated with the second axis A2 intersecting the first axis A1 as the center line.

The second movable portion 3032 is formed in a frame shape to surround the first movable portion 3031 and connected to the first movable portion 3031 via a pair of torsion bars 3038 arranged on the first axis A1. The support portion 3033 is formed in a frame shape to surround the second movable portion 3032 and connected to the second movable portion 3032 via a pair of torsion bars 3039 arranged on the second axis A2.

The first drive coil 3034 is provided on the first movable portion 3031. A first drive signal for oscillating the mirror 3003 with the first axis A1 as the center line is input to the first drive coil 3034 through a control portion (not shown). The second drive coil 3035 is provided on the second movable portion 3032. Moreover, a second drive signal for oscillating the mirror 3003 with the second axis A2 as the center line is input to the second drive coil 3035 through the control portion (not shown). The magnet 3037 generates a magnetic field acting on the first drive coil 3034 and the second drive coil 3035.

The first drive signal is an electrical signal for allowing the mirror 3003 to perform a resonance operation with the first axis A1 as the center line. When the first drive signal is input to the first drive coil 3034, a Lorentz force acts on the first drive coil 3034 due to interaction with the magnetic field generated by the magnet 3037. In addition to this Lorentz force, the mirror 3003 can be allowed to perform the resonance operation with the first axis A1 as the center line by using the resonance of the mirror 3003 and the first movable portion 3031 at a natural frequency.

The second drive signal is an electrical signal for allowing the mirror 3003 to perform a linear operation with the second axis A2 as the center line. When the second drive signal is input to the second drive coil 3035, the Lorentz force acts on the second drive coil 3035 due to interaction with a magnetic field generated by the magnet 3037. By using a balance between the Lorentz force and the elastic force of a pair of torsion bars 3039, the mirror 3003 can be allowed to perform a linear operation with the second axis A2 as the center line.

The above-described control portion (not shown) controls the laser module 1000 together with the control of the MEMS mirror device 3000A. The control of the laser module 1000 includes the control of a timing of the start or end of the projection display of the retinal projection display device and the control of a color tone based on electric current modulation for an optical semiconductor element or voltage modulation for the Mach-Zehnder-type optical waveguide.

For example, when the control portion receives an input signal for starting the projection display, the control portion causes the operation of the MEMS mirror device 3000A to start. Thereby, the MEMS mirror device 3000A causes an output from each optical semiconductor element of the laser module 1000 to start after the oscillation of the mirror 3003 starts and it is confirmed that the oscillation state has reached a steady state and is normal by using some means for monitoring the oscillation state of the MEMS mirror device 3000A. This is because the laser will be intensively radiated to a part or a single point of the retina and a risk of retinal damage may occur if the laser light is radiated to the retina while the MEMS mirror is not operating. Thereby, the laser light L1 is output from the laser module 1000. Thereby, the scanning process is performed with the laser light L1 output from the laser module 1000.

### (Movement Means)

As the movement means (actuator) of the projector module, a known one can be used in addition to the linear actuator described above.

For example, an actuator using a spherical motor can be used. In FIG. 7(a), a schematic view of a general motor is shown. In FIG. 7(b), a schematic view of a spherical motor is shown. While the general motor has only one degree of freedom of rotation with respect to the rotating axis, the spherical motor does not have a specific rotation axis, triaxial rotation with a single motor is possible, and therefore size reduction and weight reduction are possible.

When an actuator using the spherical motor is used, because the angle of the projector module can be changed with the movement of the projector module and the center of the projection image can move in a visual line direction of the gaze, the image can be effectively projected in a wider range. Moreover, as compared with an actuator with planar movement, because the convergence point of the light beam can be moved according to the three-dimensional movement of the pupil, vignetting in the pupil occurs with the movement of the pupil and a field of view does not become narrow even if the viewing angle is large.

As the spherical motor, any type such as a magnetostrictive type, a piezoelectric type, or an electromagnetic type can be used.

In FIG. 7(c), a magnetostrictive spherical motor using a magnetostrictive material for a spherical rotor is shown (see Patent Documents 3 and 4). For example, the size of the spherical motor can be within several millimeters (mm) in length, width, and depth.

A magnetostrictive spherical motor using a Fe—Ga alloy as a magnetostrictive material with a large magnetostrictive amount is preferred. Although a displacement amount of magnetostrictive materials is not as large as that of super-magnetostrictive materials containing rare earth elements, the magnetostrictive materials have workability and high rigidity and are inexpensive as compared with super-magnetostrictive materials made of rare earth alloys.

In FIG. 7, the spherical rotor includes a sphere rotor, a permanent magnet, a fixation portion, a drive body A1, a drive body A2, a drive body B1, and a drive body B2. The sphere rotor is a magnetic body formed in a spherical shape. The spherical motor can control the sphere rotor to rotate in any direction of three axes (i.e., an x-axis, a y-axis, and a z-axis). For example, if the fixation stage 5000 is attached to the tip of a sphere rotor, the fixation stage 5000 can be freely controlled in three axial directions.

As a movement means, a voice coil motor (VCM) may be used.

As the VCM, either a 2-axis VCM or a 3-axis VCM can be used.

In the VCM, it is preferable that a magnetic fluid be filled in a gap between magnetic circuits sandwiching a coil. The magnetic fluid is constrained to the gap by a magnetic field. Because the magnetic fluid has higher thermal conductivity than air, heat generated from an RGB laser module, a MEMS mirror, or the like is effectively transferred from the coil to the substrate that holds a magnet, a yoke, and an actuator in place through the magnetic fluid. Although the magnetization of the magnetic fluid is not large, the magnetic fluid is still expected to have a slight thrust improvement effect.

### (Laser Module)

As long as a plurality of laser chips and a mechanism for multiplexing light output from a plurality of laser chips are provided as the laser module, a known laser module can be used without particular limitation. Examples of the multiplexing mechanism can include a multiplexing mechanism using a planar lightwave circuit (PLC) having a directional coupler or a Mach-Zehnder-type optical waveguide and the like.

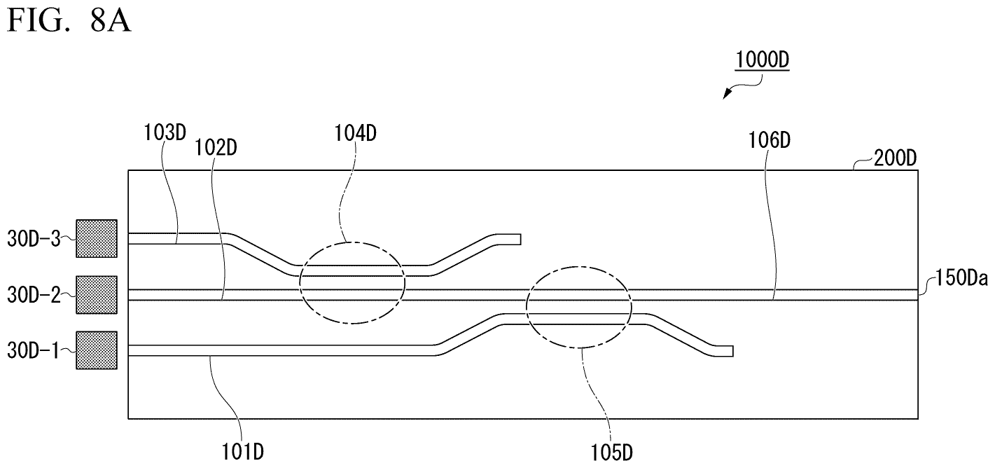

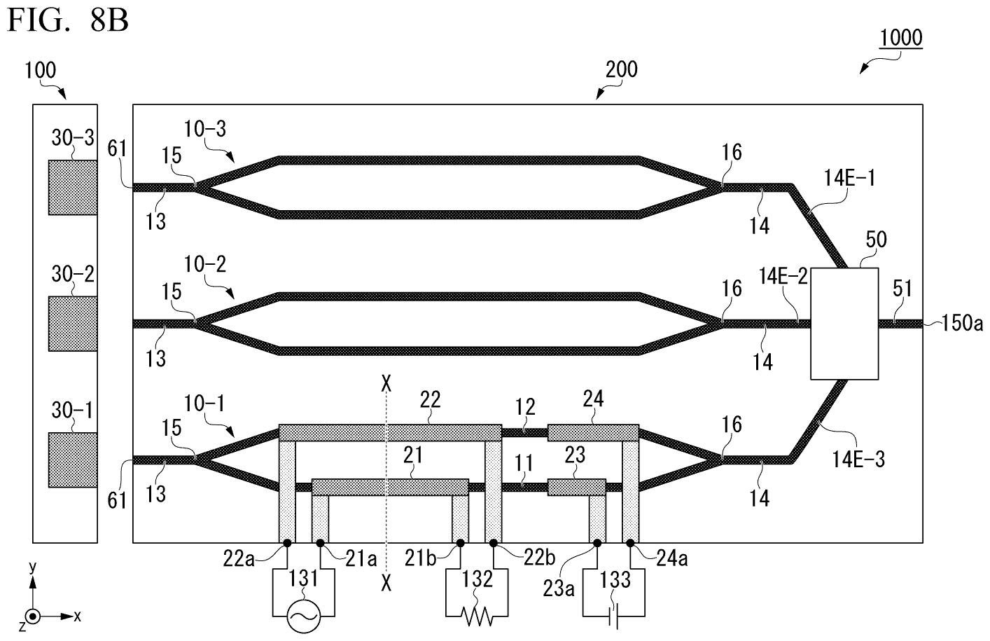

FIG. 8A is a top view schematically showing a laser module 1000D including a plurality of semiconductor elements (laser chips) 30D-1, 30D-2, and 30D-3 and a planar lightwave circuit 200D configured to multiplex light output from the plurality of semiconductor elements 30D-1, 30D-2, and 30D-3.

The planar lightwave circuit 200D includes a waveguide structure having three input ports and one output port. Specifically, the planar lightwave circuit 200D includes a first input waveguide 101D, a second input waveguide 102D, and a third input waveguide 103D to which light output from the semiconductor elements 30D-1, 30D-2, and 30D-3 is input, a first directional coupler 104D, a second directional coupler 105D, and an output waveguide 106D connected to the second input waveguide 102D.

In the laser module 1000D shown in FIG. 8A, for example, blue light B (wavelength λ1) is input to the first input waveguide 101D, green light G (wavelength λ2) is input to the second input waveguide 102D, and red light R (wavelength λ3) is input to the third input waveguide 103D. Three-color light R, G, and B is multiplexed by the first directional coupler 104D and the second directional coupler 105D to output light from an output port 150Da of the output waveguide 106D.

A waveguide length, a waveguide width, and a gap between waveguides are designed so that the first directional coupler 104D couples the light of λ1 input from the first input waveguide 101D to the second input waveguide 102D, couples the light of λ2 input from the second input waveguide 102D to the first input waveguide 101D, and recouples it to the second input waveguide 102D. A waveguide length, a waveguide width, and a gap between waveguides are designed so that the second directional coupler 105D couples the light of λ3 input from the third input waveguide 103D to the second input waveguide 102D and the light of λ1 and λ2 coupled to the second input waveguide 102D in the first directional coupler 104D is transmitted.

The color tone of the light output from the output port 150Da can be adjusted by modulation (electric current modulation) based on the driving current to the optical semiconductor element. Electric current modulation for the optical semiconductor element may be performed as electric current modulation independently for each of the plurality of optical semiconductor elements. Moreover, only a part of the optical semiconductor element may perform electric current modulation.

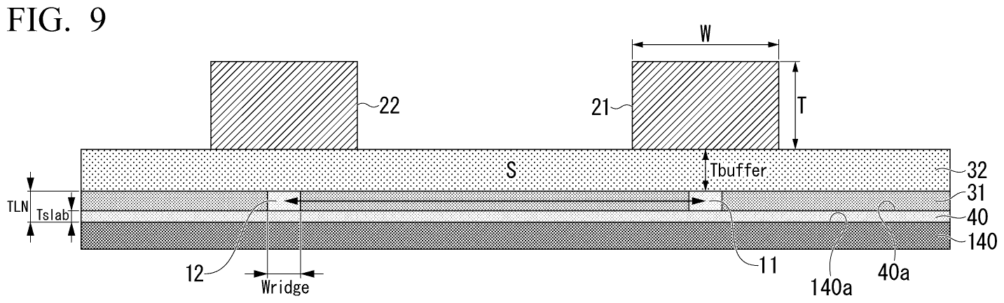

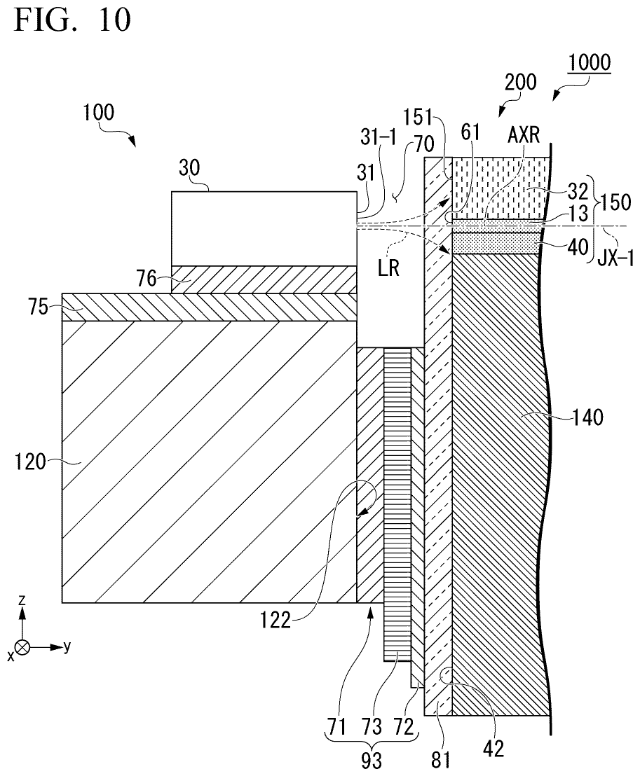

FIG. 8B is a top view schematically showing the laser module 1000. In FIG. 8B, only a part of the electrode for applying a phase difference to the Mach-Zehnder-type optical waveguide is shown. FIG. 9 is a schematic cross-sectional view cut along line X-X in FIG. 8B. FIG. 10 is a schematic cross-sectional view cut along line Y-Y in FIG. 8B.

The laser module 1000 shown in FIG. 8B includes a plurality of semiconductor elements (laser chips) 30-1, 30-2, and 30-3 (hereinafter, a plurality of Mach-Zehnder-type optical waveguides 10-1, 10-2, and 10-3 in which light output from the “optical semiconductor element 30” is guided are collectively referred to as “Mach-Zehnder-type optical waveguides 10”) and a multiplexing portion 50 in which modulated light from the Mach-Zehnder-type optical waveguides 10-1, 10-2, and 10-3 is multiplexed. The light multiplexed by the multiplexing portion 50 is collimated by the collimation lens 2000 and a direction of the collimated light is changed by the optical scanning device 3000 and a scanning process is performed therewith.

The laser module 1000 shown in FIG. 8B includes a light source unit 100 having three optical semiconductor elements 30-1, 30-2, and 30-3 (hereinafter collectively referred to as “optical semiconductor elements 30”) configured to output light of visible light wavelengths of 400 nm to 700 nm and an optical modulation/output portion 200 having three Mach-Zehnder-type optical waveguides 10-1, 10-2, and 10-3 (hereinafter collectively referred to as “Mach-Zehnder-type optical waveguides 10”) to which light output from the optical semiconductor elements 30-1, 30-2, and 30-3 is input and a lithium niobate film is formed in a convex shape with respect to the three optical semiconductor elements 30-1, 30-2, and 30-3.

Moreover, the optical semiconductor elements 30-1, 30-2, and 30-3 are mounted on the subcarrier (base) 120 and the Mach-Zehnder-type optical waveguides 10-1, 10-2, and 10-3 are formed on the substrate 140.

In the laser module 1000, the size of the optical waveguide can be reduced to 1 mm or less using an optical waveguide made by processing a single crystal thin lithium niobate film in a convex shape and the size of the laser module can be reduced. Moreover, no electric current is substantially required for intensity modulation because the external modulator having extremely high insulation properties is controlled by a voltage and power consumption is low because it operates with the minimum electric current necessary for laser light emission.

From the viewpoint of miniaturization, the advantages of a case where a lithium niobate film is used when an optical waveguide is manufactured as compared to a case where a bulk lithium niobate single crystal is used when an optical waveguide is manufactured will be described.

In the case where a bulk lithium niobate single crystal is used when an optical waveguide is manufactured, a Ti diffusion waveguide diffuses Ti into the bulk lithium niobate single crystal to produce a part having a refractive index higher than a refractive index of the original single crystal therearound. On the other hand, in the case where a lithium niobate film is used when an optical waveguide is produced, the lithium niobate film is processed to produce a convex portion that becomes an optical waveguide. This convex portion is smaller in size as compared with the Ti diffusion waveguide.

Furthermore, when a bulk lithium niobate single crystal is used, a refractive index difference Δn between the Ti diffusion waveguide (core) and the single crystal portion (cladding) therearound is small. This is because a small amount of Ti is added to a bulk lithium niobate single crystal to produce the refractive index difference Δn. On the other hand, when a lithium niobate film is used, because all the surroundings of the convex portion (core) correspond to the cladding, it is possible to increase the refractive index difference Δn if the surrounding materials (a sapphire substrate and side and top surface materials of the waveguide) can be appropriately selected. As a result, the optical waveguide can be curved with high curvature and this curvature can further reduce a longitudinal size. Furthermore, because it is possible to lengthen an interaction length while reducing the size of an outer shape, the drive voltage can be reduced.

### (Optical Semiconductor Element (Laser Chip))

Various types of laser elements can be used as the optical semiconductor element (laser chip) 30. For example, commercially available laser diodes (LDs) of red light, green light, blue light, and the like can be used. For the red light, light having a peak wavelength of 610 nm or more and 750 nm or less can be used. For the green light, light having a peak wavelength of 500 nm or more and 560 nm or less can be used. For the blue right, light having a peak wavelength of 435 nm or more and 480 nm or less can be used.

In the laser module 1000 shown in FIG. 8B, it is assumed that the optical semiconductor elements 30-1, 30-2, and 30-3 are an LD emitting blue light, an LD emitting green light, and an LD emitting red light, respectively. The LDs 30-1, 30-2, and 30-3 are spaced apart from each other in a direction substantially orthogonal to an output direction of light emitted from each LD and are provided on an upper surface 121 of a subcarrier 120. Hereinafter, in relation to reference sign Z of any constituent element, content common to constituent elements of reference signs Z-1, Z-2, . . . , Z-K may be collectively denoted by reference sign Z. The aforementioned K is a natural number of 2 or more.

Although an example in which the number of optical semiconductor elements is three in the laser module 1000 shown in FIG. 8B has been described, the number of optical semiconductor elements is not limited to three and may be two or four or more. The plurality of optical semiconductor elements may have different wavelengths of light to be emitted or there may be optical semiconductor elements having the same wavelength of light to be emitted. Moreover, light other than red (R), green (G), and blue (B) light can be used as the light to be emitted and the mounting order of red (R), green (G), and blue (B) described using the drawings is not necessary to be in this order and can be changed appropriately.

The LD 30 can be implemented on the subcarrier 120 with a bare chip. The subcarrier 120 is made of, for example, aluminum nitride (AlN), aluminum oxide (Al₂O₃), silicon (Si), or the like. As shown in FIG. 10, metallic layers 75 and 76 are provided between the subcarrier 120 and the LD 30. The subcarrier 120 and the LD 30 are connected via the metallic layers 75 and 76. As the method of forming the metallic layers 75 and 76, a known method can be used and is not particularly relevant, but a known method such as sputtering, vapor deposition, or application of a pasted metal can be used. The metallic layers 75 and 76, for example, may include one or more metals selected from the group consisting of gold (Au), platinum (Pt), silver (Ag), lead (Pb), indium (In), nickel (Ni), titanium (Ti), tantalum (Ta), tungsten (W), an alloy of gold (Au) and tin (Sn), a tin (Sn)-silver (Ag)-copper (Cu)-based solder alloy (SAC), SnCu, InBi, SnPdAg, SnBiIn, PbBiIn, and the like or may be composed of one or more metals selected from the group.

Although the substrate 140 is not particularly limited as long as the refractive index is lower than that of the lithium niobate film constituting the Mach-Zehnder-type optical waveguide, a substrate capable of forming a single crystal lithium niobate film as an epitaxial film is preferred and a single crystal sapphire substrate is preferred. A crystal orientation of the single crystal substrate is not particularly limited. However, for example, because the lithium niobate film having a c-axis orientation has three-fold symmetry, the underlying single crystal substrate also desirably has the same symmetry and a C-surface substrate is preferred in the case of the single crystal sapphire substrate.

As shown in FIG. 10, the input port 61 of the input path 13 of each Mach-Zehnder-type optical waveguide 10 is opposed to the output port 31-1 of each LD 30 and the light output from an output surface 31 of the LD 30 is positioned so that it can be input to the input path 13. An axis JX-1 of the input path 13 is substantially overlapping an optical axis AXR of the laser beam LR output from the output port 31-1 of the LD 30. With such a configuration and arrangement, the blue light, green light, and red light emitted from the LDs 30-1, 30-2, and 30-3 can be input to the input paths 13 of the Mach-Zehnder-type optical waveguides 10.

As shown in FIG. 10, the subcarrier 120 can be configured to be directly bonded to the substrate 140 via the metallic layer 93 (a first metallic layer 71, a second metallic layer 72, and a third metallic layer 73). With this configuration, further miniaturization is possible without spatially coupling or fiber coupling.

In the present embodiment, the side surface (first side surface) 122 facing the substrate 140 in the subcarrier 120 and the side surface (second side surface) 42 facing the subcarrier 120 in the substrate 140 are connected via the first metallic layer 71, the second metallic layer 72, the third metallic layer 73, and the antireflection film 81. The melting point of the metallic layer 75 is higher than the melting point of the third metallic layer 73.

The first metallic layer 71 is provided in contact with the side surface 122 in sputtering, vapor deposition, or the like, and may include one or more metals selected from the group consisting of, for example, gold (Au), platinum (Pt), silver (Ag), lead (Pb), indium (in), nickel (Ni), titanium (Ti), and tantalum (Ta) or may be composed of one or more metals selected from this group. Preferably, the first metallic layer 71 includes at least one metal selected from the group consisting of gold (Au), platinum (Pt), silver (Ag), lead (Pb), indium (In), and nickel (Ni). The second metallic layer 72 is provided in contact with the side surface 42 in sputtering, vapor deposition, or the like, and may include, for example, one or more metals selected from the group consisting of titanium (Ti), tantalum (Ta) and tungsten (W) or may be composed of one or more metals selected from this group. Preferably, tantalum (Ta) is used for the second metallic layer 72. The third metallic layer 73 is interposed between the first metallic layer 71 and the second metallic layer 72 and may include one or more metals selected from the group consisting of, for example, aluminum (Al), copper (Cu), AuSn, SnCu, InBi, SnAgCu, SnPdAg, SnBiIn, and PbBiIn or may be composed of one or more metals selected from this group. Preferably, AuSn, SnAgCu, and SnBiIn are used for the third metallic layer 73.

The thickness of the first metallic layer 71, i.e., the size of the first metallic layer 71 in the y-direction, is, for example, 0.01 μm or more and 5.00 μm or less. The thickness of the second metallic layer 72, i.e., the size of the second metallic layer 72 in the y-direction, is, for example, 0.01 μm or more and 1.00 μm or less. The thickness of the third metallic layer 73, i.e., the size of the third metallic layer 73 in the y-direction, is, for example, 0.01 μm or more and 5.00 μm or less. Moreover, the thickness of the third metallic layer 73 is preferably greater than the thickness of each of the first metallic layer 71 and the second metallic layer 72. In such a configuration, each of the aforementioned roles of the first metallic layer 71, the second metallic layer 72, and the third metallic layer 73 is well expressed and the entry of the material of the first metallic layer 71 for the substrate 140 and the deterioration in the adhesive strength between metallic layers are suppressed. The thicknesses of the first metallic layer 71, the second metallic layer 72, and the third metallic layer 73 are measured, for example, with spectroscopic ellipsometry.

The first metallic layer 71 is provided on a side facing the substrate 140 or an optical modulation structure layer 150 in substantially the entire surface of the side surface 122 without contact with the metallic layer 75. The front end of the second metallic layer 72 and the third metallic layer 73 in the z-direction, i.e., the upper end, for example, reaches the same position as the upper end of the first metallic layer 71 on the front side in the z-direction. The rear end of the second metallic layer 72 and the third metallic layer 73 in the z-direction, i.e., the lower end, for example, reaches the same position as the lower end of the subcarrier 20, the first metallic layer 71, and the substrate 140. When seen along the y-direction, the first metallic layer 71 is formed to be larger than the subcarrier 20 in the x-direction.

As in the above-described configuration, an area of the first metallic layer 71, i.e., a size in a plane including the x-direction and the z-direction, is substantially the same as areas of the second metallic layer 72 and the third metallic layer 73 and the lower ends thereof preferably reach the same position as the lower end of the subcarrier 120. In such a configuration, the maximum connection strength of the subcarrier 120 for the substrate 140 is ensured. That is, for example, even if each of the LD 30 and the subcarrier 120 and an internal electrode pad corresponding to each LD 30 among the plurality of internal electrodes are connected by a wire using wire bonding, it is possible to suppress the disconnection between the subcarrier 120 and the substrate 140. Moreover, a heat dissipation path from the subcarrier 120 can be increased when lower ends of the subcarrier 20, the first metallic layer 71, the second metallic layer 72, the third metallic layer 73, and the substrate 140 reach the same position. Further, the area of the first metallic layer 71 may be smaller than the areas of the second metallic layer 72 and the third metallic layer 73.

In the laser module 1000, an antireflection film 81 is provided between the LD 30 and the optical modulation structure layer 150. For example, the antireflection film 81 is integrally formed on the side surface 42 of the substrate 140 and the input surface 151 of the optical modulation structure layer 150. However, the antireflection film 81 may be formed only on the input surface 151 of the optical modulation structure layer 150.

The antireflection film 81 is a film for preventing input light for the optical modulation structure layer 150 from reflecting in a direction opposite to a direction of entry from the input surface 151 and increasing the transmittance of input light. The antireflection film 81 is, for example, a multilayer film formed by alternately laminating a plurality of types of dielectrics at predetermined thicknesses corresponding to the wavelengths of red light, green light, and blue light, which are input light. Examples of the dielectric include titanium oxide (TiO₂), tantalum oxide (Ta₂O₅), silicon oxide (SiO₂), aluminum oxide (Al₂O₃), and the like.

The output surface 31 of the LD 30 and the input surface 151 of the optical modulation structure layer 150 are arranged at predetermined intervals. The input surface 151 is facing the output surface 31 and there is a gap 70 between the output surface 31 and the input surface 151 in the y-direction. Because the laser module 1000 is exposed in the air, the gap 70 is filled with air. Because the gap 70 is filled with the same gas (air), it is easy to input color light output from the LD 30 to the input path while satisfying predetermined coupling efficiency. When the laser module 1000 is used for AR glasses and VR glasses, the size of the gap (spacing) 70 in the y-direction is, for example, 0 μm or more and 5 μm or less, on the basis of the amount of light required by the AR glasses and the VR glasses and the like.

### (Mach-Zehnder-Type Optical Waveguide)

In a Mach-Zehnder-type optical waveguide, a light beam with the same wavelength and phase is divided (separated) into two pairs of beams and the beams are given different phases and then merged (multiplexed). An intensity of the multiplexed light beam changes with a phase difference.

The optical modulation/output portion 200 includes three Mach-Zehnder-type optical waveguides 10-1, 10-2, and 10-3. The number of Mach-Zehnder-type optical waveguides 10-1, 10-2, and 10-3 is equal to the number of optical semiconductor elements 30-1, 30-2, and 30-3. The optical semiconductor elements 30-1, 30-2, and 30-3 and the Mach-Zehnder-type optical waveguides 10-1, 10-2, and 10-3 are positioned so that the light output from the optical semiconductor element is input to the corresponding Mach-Zehnder-type optical waveguide.

The Mach-Zehnder-type optical waveguides 10 (10-1, 10-2, and 10-3) shown in FIG. 8B include a first optical waveguide 11, a second optical waveguide 12, an input path 13, an output path 14, a branch portion 15, and a coupling portion 16. Although the first optical waveguide 11 and the second optical waveguide 12 shown in FIG. 1 are configured to extend in a straight-line shape in the x-direction in a region other than regions near the branch portion 15 and the coupling portion 16, the present invention is not limited to this configuration. The lengths of the first optical waveguide 11 and the second optical waveguide 12 shown in FIG. 1 are substantially the same. The branch portion 15 is located between the input path 13 and the first optical waveguide 11 and the second optical waveguide 12. The input path 13 is connected to the first optical waveguide 11 and the second optical waveguide 12 via the branch portion 15. The coupling portion 16 is located between the first optical waveguide 11 and the second optical waveguide 12 and the output path 14. The first optical waveguide 11 and the second optical waveguide 12 are connected to the output path 14 via the coupling portion 16.

The Mach-Zehnder-type optical waveguide 10 includes the first optical waveguide 11 and the second optical waveguide 12 that are ridge portions (convex types) protruding from a first surface 40a of a slab layer 40 made of lithium niobate. Hereinafter, the slab layer 40 made of lithium niobate and the ridge portions 11 and 12 made of lithium niobate are combined to form a lithium niobate film. The first surface 40a is an upper surface of a portion other than the ridge portion of the lithium niobate film. The two ridge portions (a first ridge portion and a second ridge portion) protrude from the first surface 40a in the z-direction and extend along the Mach-Zehnder-type optical waveguide 10. In the present embodiment, the first ridge portion is designated as the first optical waveguide 11 and the second ridge portion functions as the second optical waveguide 12.

A shape of cross-section X-X (a cross-section perpendicular to a direction of travel of light) of the ridge portion (the first optical waveguide 11 and the second optical waveguide 12) shown in FIG. 9 is rectangular. A width (Wridge) in the y-direction is, for example, 0.3 μm or more and 5.0 μm or less. A height of the ridge portion (a protrusion height H (=T_{slab}−T_{LN}) from the first surface 40a) is, for example, 0.1 μm or more and 1.0 μm or less.

The shape of the ridge portion (the first optical waveguide 11 and the second optical waveguide 12) may be any shape, for example, a dome shape or a triangular shape, as long as it can guide light.

The slab layer 40 made of lithium niobate is, for example, a lithium niobate film oriented in the c-axis. The slab layer 40 made of lithium niobate is, for example, an epitaxial film epitaxially grown on the substrate 140. The epitaxial film is a single crystal film whose crystal orientation is aligned by the underlying substrate. The epitaxial film is a film having a single crystal orientation in the z-direction and the xy-plane direction, and the crystal is aligned and oriented in the x-, y-, and z-axis directions. Whether or not it is an epitaxial film can be proved, for example, by checking the peak intensity and the pole point at the orientation position in 2θ-θ X-ray diffraction. Moreover, the lithium niobate film 40 made of lithium niobate may be a lithium niobate film provided on a Si substrate via SiO₂.

Lithium niobate is a compound represented by LixNbAyOz. A is an element other than Li, Nb, and O. Examples of the element represented by A can include K, Na, Rb, Cs, Be, Mg, Ca, Sr, Ba, Ti, Zr, Hf, V, Cr, Mo, W, Fe, Co, Ni, Zn, Sc, Ce, and the like. For these elements, one type may be used alone or a combination of two or more types may be used. x denotes a number between 0.5 and 1.2. x is preferably a number between 0.9 and 1.05. y represents a number between 0 and 0.5. z represents a number between 1.5 and 4.0. z is preferably a number between 2.5 and 3.5.

### (Electrodes)

The electrodes 21 and 22 are electrodes for applying a modulation voltage Vm to each of the Mach-Zehnder-type optical waveguides 10-1, 10-2, and 10-3 (hereinafter simply referred to as “each Mach-Zehnder-type optical waveguide 10”). The electrode 21 is an example of the first electrode and the electrode 22 is an example of the second electrode. A first end 21a of the electrode 21 is connected to a power supply 131 and a second end 21b is connected to a termination resistor 132. A first end 22a of the electrode 22 is connected to the power supply 131 and a second end 22b is connected to the termination resistor 132. The power supply 131 is a part of a drive circuit 210 for applying a modulation voltage Vm to each Mach-Zehnder-type optical waveguide 10.

The electrodes 23 and 24 are electrodes for applying a direct current (DC) bias voltage Vdc to each Mach-Zehnder-type optical waveguide 10. The first end 23a of the electrode 23 and the first end 24a of the electrode 24 are connected to a power supply 133. The power supply 133 is a part of a DC bias application circuit 220 for applying a DC bias voltage Vdc to each Mach-Zehnder-type optical waveguide 10.

In FIG. 9, the line width and line spacing of the electrode 21 and the electrode 22 arranged in parallel are wider than actual for ease of viewing. Therefore, a length of a portion (interaction length) in which the electrode 21 and the first optical waveguide 11 overlap and the length of the portion in which the electrode 22 and the second optical waveguide 12 overlap appear to be different, but these lengths (interaction lengths) are substantially the same. Likewise, the length of the portion in which the electrode 23 and the first optical waveguide 11 overlap (interaction length) is substantially the same as the length of the portion in which the electrode 24 and the second optical waveguide 12 overlap (interaction length).

Moreover, when the DC bias voltage Vdc is superimposed on the electrodes 21 and 22, the electrodes 23 and 24 may not be provided. Moreover, a ground electrode may be provided around the electrodes 21, 22, 23, and 24.

The electrodes 21, 22, 23, and 24 sandwich a buffer layer 32 and are located on the slab layer 40 made of lithium niobate and the ridge portions 11 and 12 made of lithium niobate. The electrodes 21 and 23 can each apply an electric field to the first optical waveguide 11. Each of the electrodes 21 and 23 is at a position that overlaps, for example, the first optical waveguide 11 in a top view from the z-direction. The electrodes 21 and 23 are each located above the first optical waveguide 11. Each of the electrodes 22 and 24 can apply an electric field to the second optical waveguide 12. Each of the electrodes 22 and 24 is at a position that overlaps, for example, the second optical waveguide 12 in the top view from the z-direction. Each of the electrodes 22 and 24 is located above the second optical waveguide 12.

The buffer layer 32 is located between each Mach-Zehnder-type optical waveguide 10 and the electrodes 21, 22, 23, and 24. A protective layer 31 and the buffer layer 32 coat and protect the ridge portion. Moreover, the buffer layer 32 also prevents light propagating through each Mach-Zehnder-type optical waveguide 10 from being absorbed by the electrodes 21, 22, 23, and 24. The buffer layer 32 has a lower refractive index than the lithium niobate film 40. Each of the protective layer 31 and the buffer layer 32 is, for example, SiInO, SiO₂, Al₂O₃, MgF₂, La₂O₃, ZnO, HfO₂, MgO, Y₂O₃, CaF₂, In₂O₃, or the like or a mixture thereof. The protective layer 31 and the buffer layer 32 may be made of the same material or different materials. When protective layer 31 and the buffer layer 32 may be of different materials, it is possible to appropriately select the materials from the viewpoint of DC drift improvement, Vπ reduction, propagation loss reduction, and the like.

The size of the optical modulation/output portion 200 including the Mach-Zehnder-type optical waveguide 10 is, for example, 100 mm² or less. If the size of the optical modulation/output portion 200 is 100 mm² or less, it is suitable for AR glasses or VR glasses.

The optical modulation/output portion 200 including the Mach-Zehnder-type optical waveguide 10 can be produced in a known method. For example, the optical modulation/output portion 200 is produced using semiconductor processes such as epitaxial growth, photolithography, etching, vapor deposition, and metallization.

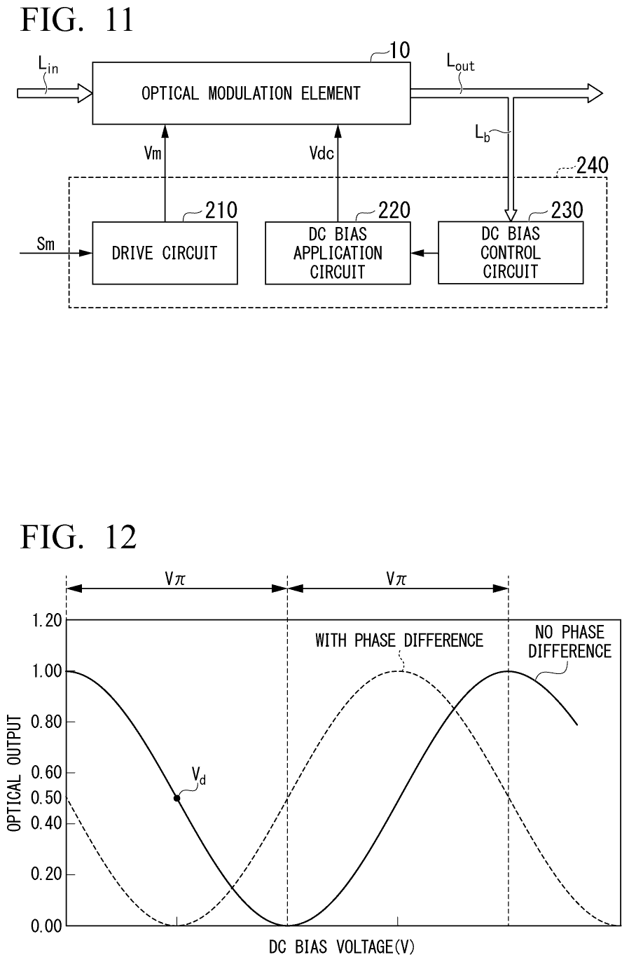

FIG. 11 is a block diagram of the optical modulation/output portion 200.

The control portion 240 of the optical modulation/output portion 200 includes a drive circuit 210, a DC bias application circuit 220, and a DC bias control circuit 230. The drive circuit 210 applies a modulation voltage Vm corresponding to a modulation signal Sm to the Mach-Zehnder-type optical waveguide 10. The DC bias application circuit 220 applies a DC bias voltage Vdc to the Mach-Zehnder-type optical waveguide 10. The DC bias control circuit 230 monitors output light Lout and controls the DC bias voltage Vdc output from the DC bias application circuit 220. By adjusting the DC bias voltage Vdc, the operating point Vd to be described below is controlled.

The optical modulation/output portion 200 converts an electrical signal into an optical signal. The optical modulation/output portion 200 modulates input light Lᵢₙ output from the optical semiconductor element 30 and input from the input path 13 of the Mach-Zehnder-type optical waveguide 10 into the output light Lₒᵤₜ. A modulation operation of the optical modulation/output portion 200 will be described.

The input light Lᵢₙ output from the optical semiconductor element 30 and input from the input path 13 branches to the first optical waveguide 11 and the second optical waveguide 12 and propagates therethrough. A phase difference between the light propagating through the first optical waveguide 11 and the light propagating through the second optical waveguide 12 is zero at the time of branching.

Subsequently, a voltage is applied between the electrode 21 and the electrode 22. For example, differential signals having the same absolute value, positive and negative values opposite to each other, and phases not shifted from each other may be applied to the electrode 21 and the electrode 22. The refractive indices of the first optical waveguide 11 and the second optical waveguide 12 vary with the electro-optic effect. For example, the refractive index of the first optical waveguide 11 is changed by +Δn from the reference refractive index n and the refractive index of the second optical waveguide 12 is changed by −Δn from the reference refractive index n.

A refractive index difference between the first optical waveguide 11 and the second optical waveguide 12 creates a phase difference between light propagating through the first optical waveguide 11 and light propagating through the second optical waveguide 12. The light propagating through the first optical waveguide 11 and the light propagating through the second optical waveguide 12 merge on the output path 14 and are output as the output light Lₒᵤₜ. The output light Lₒᵤₜ is obtained by a superposition of the light propagating through the first optical waveguide 11 and the light propagating through the second optical waveguide 12. The intensity of the output light Lₒᵤₜ varies with a phase difference of an odd number multiple between the light propagating through the first optical waveguide 11 and the light propagating through the second optical waveguide 12. In this procedure, the Mach-Zehnder-type optical waveguide 10 modulates an input light Lᵢₙ into the output light Lₒᵤₜ in accordance with an electrical signal.

A modulation voltage Vm corresponding to the modulation signal is applied to the electrodes 21 and 22 for applying a modulation voltage of the optical modulation/output portion 200. The voltage applied to the electrodes 23 and 24 for applying the DC bias voltage, i.e., the DC bias voltage Vdc output from the DC bias application circuit 220, is controlled by the DC bias control circuit 230. The DC bias control circuit 230 adjusts an operating point Vd of the optical modulation/output portion 200 by controlling the DC bias voltage Vdc. The operating point Vd is a voltage that is the center of the modulation voltage amplitude.

An optical modulation curve of each Mach-Zehnder-type optical waveguide 10 will be described with reference to FIG. 12. FIG. 12 is a diagram showing a relationship of a DC bias voltage and an output with respect to a Mach-Zehnder-type optical waveguide not having a configuration that causes a phase difference between two optical waveguides (the first optical waveguide 11 and the second optical waveguide 12) and a Mach-Zehnder-type optical waveguide having a configuration that causes a phase difference between two optical waveguides. The horizontal axis of FIG. 12 represents a DC bias voltage applied to the electrodes 23 and 24 and the vertical axis represents a standardized output from the Mach-Zehnder-type optical waveguide 10. The output is standardized as “1” when the phase difference between the light propagating through the first optical waveguide 11 and the light propagating through the second optical waveguide 12 is zero. A solid line indicates the characteristics of a Mach-Zehnder-type optical waveguide not having a configuration that causes a phase difference and a dashed line indicates the characteristics of a Mach-Zehnder-type optical waveguide having a configuration that causes a phase difference.

In the Mach-Zehnder-type optical waveguide not having a configuration that causes a phase difference, in a state in which no voltage is applied (Vdc=0), light beams having the same phase via the two optical waveguides interfere with each other in the coupling portion 16 and strengthen each other, and an output of the Mach-Zehnder-type optical waveguide has a maximum value.

### (Multiplexing Portion)

The laser module 1000 has the multiplexing portion 50 configured to multiplex modulated light from three Mach-Zehnder-type optical waveguides in the optical modulation/output portion 200. The multiplexing portion 50 multiplexes light propagating through an output path 14E-2 of a Mach-Zehnder-type optical waveguide 10-2 and light propagating through an output path 14E-3 of a Mach-Zehnder-type optical waveguide 10-3 and outputs light from an output port 150a via an output waveguide 51. Because the multiplexer is not separated from the modulator as in Patent Document 2, the resolution, color, and the like are improved.

The color tone of the light output from the output port 150a can be adjusted in an electric current modulation process for the optical semiconductor element and a voltage modulation process for the Mach-Zehnder-type optical waveguide. Moreover, the electric current modulation process for the optical semiconductor element and the voltage modulation process for the Mach-Zehnder-type optical waveguide may be adjusted in combination. Moreover, the electric current modulation process for the optical semiconductor element may be performed independently for each of the plurality of optical semiconductor elements and the electric current modulation process may be performed for only some optical semiconductor elements. The voltage modulation process for the optical semiconductor element may be performed independently for each of the plurality of optical semiconductor elements and the voltage modulation process may be performed for only some optical semiconductor elements.

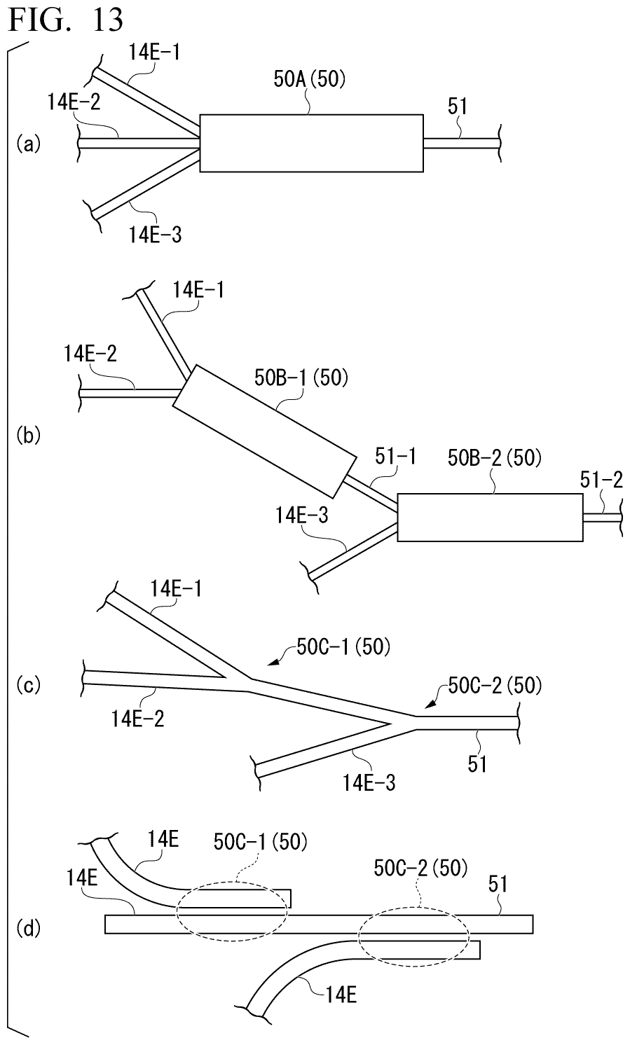

The multiplexing portion 50 may be any one selected from the group consisting of a multi-mode interferometer (MMI) type multiplexer (see FIGS. 13(a) and 13(b)), a Y-shaped multiplexer (see FIG. 13(c)), and a directional coupler (see FIG. 13(d)).

The multiplexing portion 50 shown in FIG. 13(a) is a multiplexing portion 50A configured to multiplex light propagating through an output path 14E-1 of the Mach-Zehnder-type optical waveguide 10-1, light propagating through the output path 14E-2 of the Mach-Zehnder-type optical waveguide 10-2, and light propagating through the output path 14E-3 of the Mach-Zehnder-type optical waveguide 10-3, and outputs the multiplexed light from the multiplexing portion 50A to the output waveguide 51.

Moreover, the multiplexing portion 50 shown in FIG. 13(b) includes a multiplexing portion 50B-1 configured to first multiplex light propagating through the output path 14E-1 of the Mach-Zehnder-type optical waveguide 10-1 and light propagating through the output path 14E-2 of the Mach-Zehnder-type optical waveguide 10-2 and a multiplexing portion 50B-2 configured to subsequently multiplex light obtained by outputting the multiplexed light from the multiplexing portion 50B-1 with light propagating through the output path 14E-3 of the Mach-Zehnder-type optical waveguide 10-3, and outputs the multiplexed light from the multiplexing portion 50B-2 to the output waveguide 51.

Moreover, the multiplexing portion 50 shown in FIG. 13(c) includes a multiplexing portion 50C-1 configured to first multiplex light propagating through the output path 14E-1 of the Mach-Zehnder-type optical waveguide 10-1 and light propagating through the output path 14E-2 of the Mach-Zehnder-type optical waveguide 10-2 and a multiplexing portion 50C-2 configured to subsequently multiplex light obtained by outputting the multiplexed light from the multiplexing portion 50C-1 with light propagating through the output path 14E-3 of the Mach-Zehnder-type optical waveguide 10-3, and outputs the multiplexed light from the multiplexing portion 50C-2 to the output waveguide 51.

Moreover, the multiplexing portion 50 shown in FIG. 13(d) includes a directional coupling portion 50D-1 configured to first couple light propagating through the output path 14E-1 of the Mach-Zehnder-type optical waveguide 10-1 and light propagating through the output path 14E-2 of the Mach-Zehnder-type optical waveguide 10-2 and a directional coupling portion 50D-2 configured to subsequently couple the multiplexed light with light propagating through the output path 14E-3 of the Mach-Zehnder-type optical waveguide 10-3, and outputs the coupled multiplexed light from the directional coupling portion 50C-2 to the output waveguide 51.

The laser module 1000 may include a controller (not shown) configured to control values of electric currents to be injected into the three optical semiconductor elements 30 so that wavelength peak outputs have a predetermined ratio in the light externally output through the three Mach-Zehnder-type optical waveguides 10. Because it depends on a user, a purpose, and the sensitivity to perceive human color vision (the most sensitive to green), appropriate selection can be performed so that the wavelength peak outputs have the predetermined ratio.

In optical waveguides, it is known that the side roughness in an etching process is a main cause of optical loss. It is also known that the optical loss due to this side roughness is larger when the wavelength is shorter.

That is, when the light propagating through the optical waveguide is blue (B), green (G), and red (R), the magnitudes of the optical loss are known as B>G>R.

Therefore, the laser module 1000 may include the three Mach-Zehnder-type optical waveguides 10 so that the values of electric currents to be injected into the three optical semiconductor elements 30 are designated as uniform values and the wavelength peak outputs in light externally output through the three Mach-Zehnder-type optical waveguides 10 (10-1, 10-2, and 10-3) have the predetermined ratio. By setting the electric current for driving the laser to the same value at wavelengths, it is possible to use a simple driver such that a simple circuit can be implemented and further miniaturization is possible.

If the configurations of the three Mach-Zehnder-type optical waveguides are the same and the optical loss due to side roughness does not depend on the color of the light propagating through the optical waveguide, an optical output ratio of output colors (or a ratio of optical outputs of colors to be multiplexed when a multiplexing portion is provided) is R:G:B=1:1:1. However, because the optical loss due to the side roughness depends on the color of the light propagating through the optical waveguide, it is possible to compensate for a difference in optical loss due to the side roughness by making the configurations of the three Mach-Zehnder-type optical waveguides different from each other.

Although a desired ratio is desired instead of R:G:B=1:1:1 depending on the purpose, the configuration of three Mach-Zehnder-type optical waveguides can be determined so that it becomes the predetermined ratio even in this case.

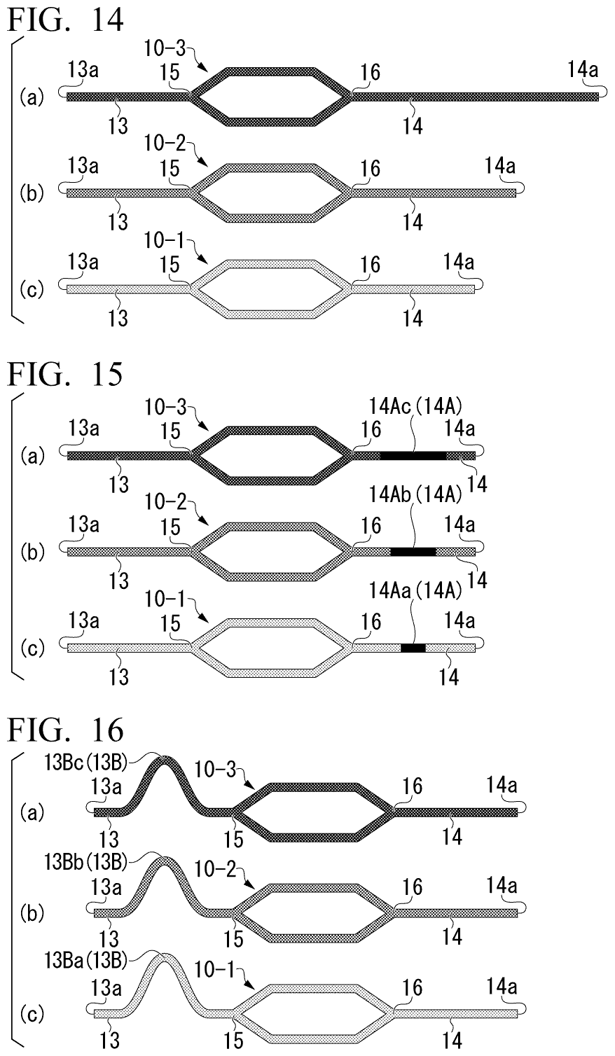

In FIGS. 14 to 16, a configuration example in which an optical output ratio of colors to be output (or a ratio of optical outputs of colors to be multiplexed when a multiplexing portion is provided) is approximated to R:G:B=1:1:1 is shown.

The configuration shown in FIG. 14 is a configuration in which a length of an optical waveguide from an input end 13a to an output end 14a of each of the three Mach-Zehnder-type optical waveguides 10 (10-1, 10-2, and 10-3) is shorter when light of a shorter wavelength propagates through the Mach-Zehnder-type optical waveguide. In response to the problem peculiar to a ridge-type waveguide structure in which the propagation loss increases as the wavelength decreases even if the side roughness of the ridge portion is the same, the propagation loss at each wavelength can be made uniform by shortening the length of the optical waveguide of the shorter wavelength structure.

According to this configuration, an optical output ratio of colors to be output (or a ratio of optical outputs of colors to be multiplexed when a multiplexing portion is provided) can be approximated to R:G:B=1:1:1.

Although the output paths 14 have different lengths from each other in the configuration shown in FIG. 14, the input paths 13 may have different lengths from each other and the input paths 13 and the output paths 14 may have different lengths from each other.

The configuration shown in FIG. 15 is a configuration in which optical absorption portions 14A (14Aa, 14Ab, and 14Ac) each made of a material absorbent with respect to a wavelength of light to be propagated in the optical waveguide from the input end 13a to the output end 14a are provided in the three Mach-Zehnder-type optical waveguides 10 (10-1, 10-2, and 10-3) and a length of the optical waveguide of the optical absorption portion 14A in a longitudinal direction is shorter when light having a shorter wavelength propagates through the Mach-Zehnder-type optical waveguide. Even in this configuration, the propagation loss at each wavelength can be made uniform.

According to this configuration, an optical output ratio of colors to be output (or a ratio of optical outputs of colors to be multiplexed when a multiplexing portion is provided) can be approximated to R:G:B=1:1:1.

Although the configuration shown in FIG. 15 may be a configuration in which the output path 14 has the optical absorption portion 14A, it may be a configuration in which the input path 13 has the optical absorption portion 14A or a configuration in which the input path 13 and the output path 14 have the optical absorption portion 14A.

The configuration shown in FIG. 16 is a configuration in which bent portions 13B (13Ba, 13Bb, and 13Bc) each having curvature in the optical waveguide from the input end 13a to the output end 14a are provided in the three Mach-Zehnder-type optical waveguides 10 (10-1, 10-2, and 10-3) and the curvature of the bent portion 13B is greater and the length of the bent portion 13B is shorter when light having a shorter wavelength propagates through the Mach-Zehnder-type optical waveguide. Even with this configuration, the propagation loss at each wavelength can be made uniform.

According to this configuration, an optical output ratio of colors to be output (or a ratio of optical outputs of colors to be multiplexed when a multiplexing portion is provided) can be approximated to R:G:B=1:1:1.

Although there is a configuration in which the curvature of the bent portion 13B is greater and the length of the bent portion 13B is shorter in the Mach-Zehnder-type optical waveguide through which light with a shorter wavelength propagates in the configuration shown in FIG. 16, a configuration in which the curvature of the bent portion 13B is greater or the length of the bent portion 13B is shorter when light having a shorter wavelength propagates through the Mach-Zehnder-type optical waveguide may be adopted.

Although there is a configuration in which the bent portion 13B is provided on the input path 13 in the configuration shown in FIG. 16, a configuration in which the bent portion 13B is provided on the output path 14 may be adopted or a configuration in which the bent portion 13B is provided on the input path 13 and the output path 14 may be adopted.

The maximum values of outputs of light output through the three Mach-Zehnder-type optical waveguides 10 (10-1, 10-2, and 10-3) may be the same intensity.

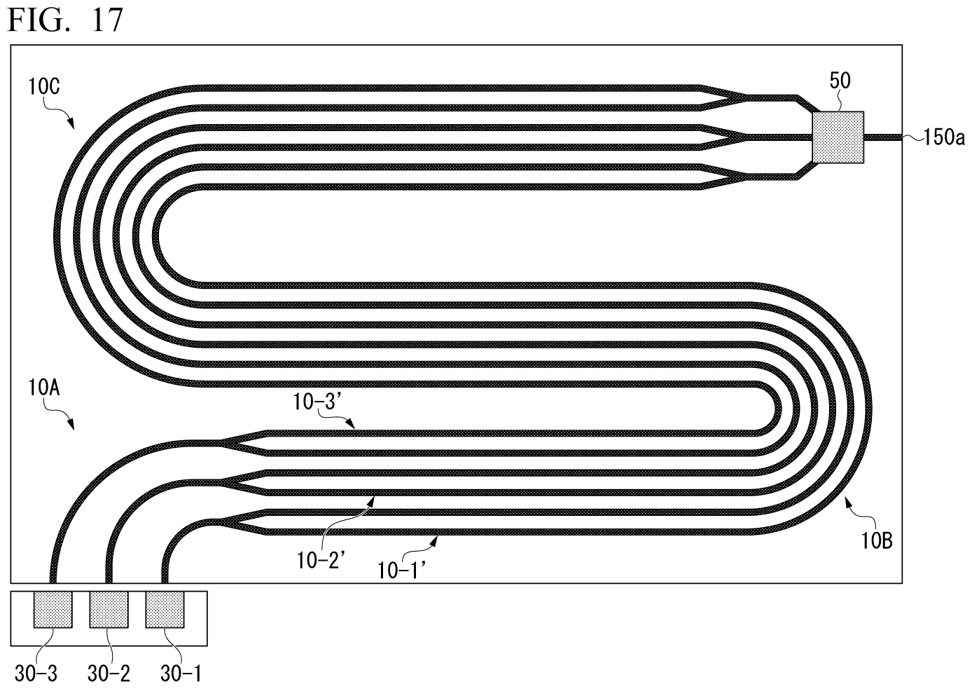

As shown in FIG. 17, Mach-Zehnder-type optical waveguides 10′ (10-1′, 10-2′, and 10-3′) may have bent portions 10A, 10B, and 10C. In the Mach-Zehnder-type optical waveguide, the bent portion may be provided for any one of parts of dual-mode waveguides 11 and 12 (parts indicated by reference signs 10B and 10C), an input path (a part indicated by reference sign 10A), and an output path.

The configuration of the optical waveguide formed by convexly processing the single crystal thin lithium niobate film formed on the substrate can provide a high refractive index difference between a core portion (single crystal thin lithium niobate film) and a cladding portion (side/top surface materials of the substrate and the optical waveguide) and can bend the optical waveguide with high curvature. The longitudinal size can be further reduced in a bending process. Also, because it is possible to extend the interaction length while reducing a size of an external form, the drive voltage can be reduced.

### [Operation Effect 1 (Movement Means 1)]

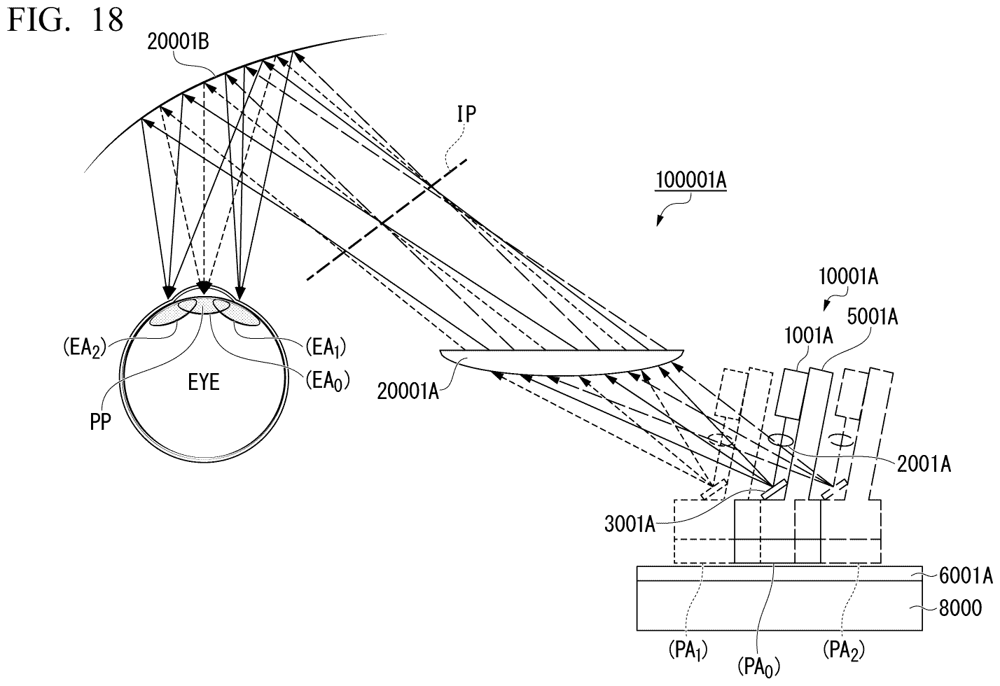

FIG. 18 is a schematic diagram for describing a process of moving the projector module in accordance with a change in the pupil position using a linear actuator as a movement means of the projector module and causing the light beam from the projector module to pass through the pupil. In FIG. 18, featured parts are shown enlarged such that the features of the present invention are easier to understand. Constituent elements having the same reference signs are assumed to have similar configurations and description thereof will be omitted.

A retinal projection display device 100001A shown in FIG. 18 includes a projector module 10001A, a movement means 6000A configured to move the projector module 10001A, and a pupil position detection means (not shown) configured to detect a pupil position, whereby the projector module 10001A can be moved by the linear actuator (movement means) 6001A in correspondence with a change in the pupil position detected by the pupil position detection means. In FIG. 18, the illustration of a guide rail and a support member between the linear actuator 6001A and the fixation base 8000 is omitted.

In FIG. 18, (EA₀), (EA₁), and (EA₂) are reference signs indicating positions of the pupil and it is indicated that the pupil position has been changed and the pupil has been located at these three locations. Moreover, (PA₀), (PA₁), and (PA₂) are reference signs indicating positions of the projector module and it is indicated that the projector module has been located at these three locations in accordance with a change in the pupil position.

The projector module 10001A includes a laser module 1001A, a collimation lens 2001A configured to convert light from the laser module 1001A into parallel light beams, and an optical scanning device 3001A configured to change a direction of light from the collimation lens 2001A to perform a scanning process. Because the laser module 1001A, the collimation lens 2001A, and the optical scanning device 3001A are fixed to the fixation stage 5001A via a support member or directly without the support member, their relative positions are uniform. Therefore, even when the projector module moves so that the light beam from the projection module can pass through the pupil in accordance with a change in the pupil position, relative positions of the laser module 1001A, the collimation lens 2001A, and the optical scanning device 3001A are fixed.

First, when the pupil is located at the position (EA₀), it is assumed that the projection module 10001A is located at the position (PA₀) so that the light beam from the projection module 10001A can pass through the pupil.

At this time, the light output from the laser module 1001A is collimated by the collimation lens 2001A and the collimated light is reflected and scanned by the optical scanning device 3001A. The light passes through an objective lens 20001A of the optical system having a Kepler-type telescope configuration and is reflected by a translucent concave surface mirror 20001B. The light converges near the pupil PP and then an image is drawn on the retina.

Subsequently, when the pupil moves from the position (EA₀) to the position (EA₁), the pupil position detection means (not shown) detects the pupil position. The movement direction and movement distance of the linear actuator 6001A are calculated by the control portion (not shown) in accordance with the pupil position, and the linear actuator 6001A moves from the position (PA₀) to the position (PA₁) in accordance with movement information thereof.

After the movement, the light output from the laser module 1001A is collimated by the collimation lens 2001A and the collimated light is reflected and scanned by the optical scanning device 3001A. The light passes through the objective lens 20001A of the optical system having a Kepler-type telescope configuration and is reflected by the translucent concave surface mirror 20001B. The light converges near the pupil PP and then an image is drawn on the retina.

Moreover, when the pupil moves from the position (EA₁) to the position (EA₂), the pupil position detection means (not shown) detects the pupil position. The movement direction and movement distance of the linear actuator 6001A are calculated by the control portion (not shown) in accordance with the pupil position, and the linear actuator 6001A moves from the position (PA₁) to the position (PA₂) in accordance with movement information thereof.

After the movement, the light output from the laser module 1001A is collimated by the collimation lens 2001A and the collimated light is reflected and scanned by the optical scanning device 3001A. The light passes through the objective lens 20001A of the optical system having a Kepler-type telescope configuration and is reflected by the translucent concave surface mirror 20001B. The light converges near the pupil PP and then an image is drawn on the retina.

Thus, according to the retinal projection display device 100001A shown in FIG. 18, the linear actuator 6001A is used as the movement means of the projector module 10001A, the projector module 10001A is moved in accordance with a change in the pupil position, and a light beam of the projector module 10001A is allowed to converge on the pupil and pass through the pupil, such that it is possible to draw an image on the retina.

### [Operation Effect 2 (Movement Means 2)]

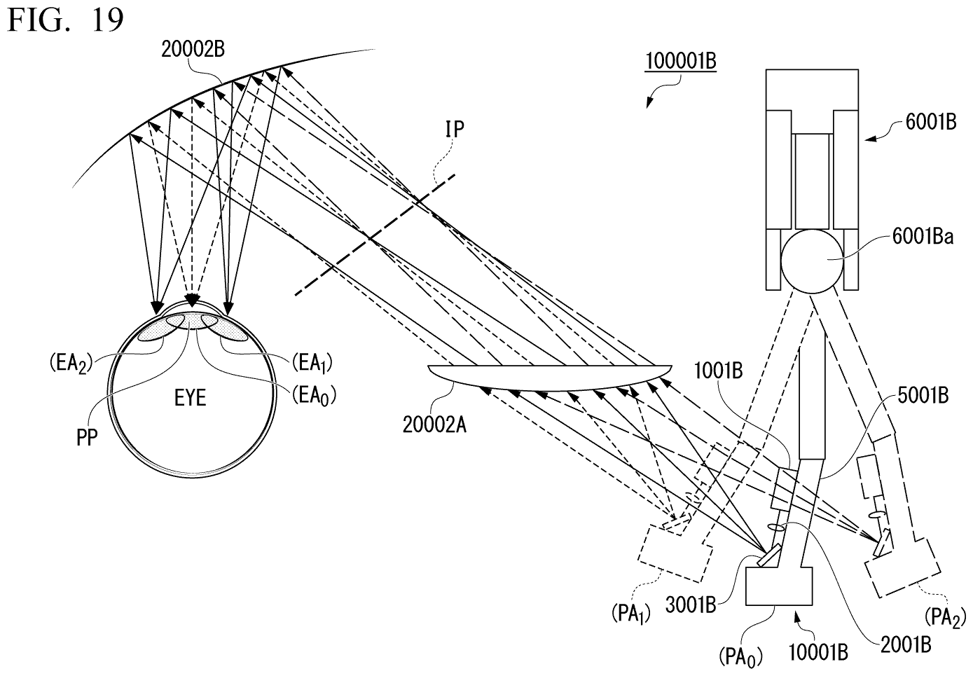

FIG. 19 is a schematic diagram for describing a process of moving the projector module in accordance with a change in the pupil position using an actuator with a spherical motor as a movement means of the projector module and causing the light beam from the projector module to pass through the pupil. In FIG. 19, featured parts are shown enlarged such that the features of the present invention are easier to understand. Constituent elements having the same reference signs are assumed to have similar configurations and description thereof will be omitted.

A retinal projection display device 100001B shown in FIG. 19 includes a projector module 10001B, an actuator 6001B using a spherical motor 6001Ba that is a movement means configured to move the projector module 10000B, and a pupil position detection means (not shown) configured to detect a pupil position, whereby the projector module 10001B can be moved by the actuator 6001B using the spherical motor 6001Ba in correspondence with a change in the pupil position detected by the pupil position detection means.

The projector module 10001B includes a laser module 1000B, a collimation lens 2001B configured to convert light from the laser module 1000B into parallel light beams, and an optical scanning device 3001B configured to change a direction of light from the collimation lens 2001B to perform a scanning process. Because the laser module 1000B, the collimation lens 2001B, and the optical scanning device 3001B are fixed to a fixation stage 5001B via a support member or directly without the support member, their relative positions are uniform. Therefore, even when the projector module moves so that the light beam from the projection module can pass through the pupil in accordance with a change in the pupil position, relative positions of the laser module 1000B, the collimation lens 2001B, and the optical scanning device 3001B are fixed.

First, when the pupil is located at the position (EA₀), it is assumed that the projection module 10001B is located at the position (PA₀) so that the light beam from the projection module 10001B can pass through the pupil.

At this time, the light output from the laser module 1001B is collimated by the collimation lens 2001B and the collimated light is reflected and scanned by the optical scanning device 3001B. The light passes through the objective lens 20002A of the optical system having a Kepler-type telescope configuration and is reflected by a translucent concave surface mirror 20002B. The light converges near the pupil PP and then an image is drawn on the retina.

Subsequently, when the pupil moves from the position (EA₀) to the position (EA₁), the pupil position detection means (not shown) detects the pupil position. The movement direction and movement distance of the actuator 6001B using the spherical motor 6001Ba are calculated by the control portion (not shown) in accordance with the pupil position, and the actuator 6001B using the spherical motor 6001Ba moves from the position (PA₀) to the position (PA₁) in accordance with movement information thereof.

After the movement, the light output from the laser module 1001A is collimated by the collimation lens 2001B and the collimated light is reflected and scanned by the optical scanning device 3001B. The light passes through the objective lens 20001A of the optical system having a Kepler-type telescope configuration and is reflected by the translucent concave surface mirror 20001B. The light converges near the pupil PP and then an image is drawn on the retina.

Moreover, when the pupil moves from the position (EA₁) to the position (EA₂), the pupil position detection means (not shown) detects the pupil position. The movement direction and movement distance of the actuator 6001B using the spherical motor 6001Ba are calculated by the control portion (not shown) in accordance with the pupil position, and the actuator 6001B using the spherical motor 6001Ba moves from the position (PA₁) to the position (PA₂) in accordance with movement information thereof.

After the movement, the light output from the laser module 1001B is collimated by the collimation lens 2001B and the collimated light is reflected and scanned by the optical scanning device 3001B. The light passes through the objective lens 20001A of the optical system having a Kepler-type telescope configuration and is reflected by the translucent concave surface mirror 20001B. The light converges near the pupil PP and then an image is drawn on the retina.

As described above, according to the retinal projection display device 100001B shown in FIG. 19, the actuator 6001B using the spherical motor 6001Ba is used as a movement means of the projector module 10001B and it is possible to move the projector module 10001B in accordance with a change in the pupil position, to cause the light beam of the projector module 10001B to converge on the pupil and pass through the pupil, and draw an image on the retina. Moreover, according to the retinal projection display device 100001B, the actuator 6001B using the spherical motor 6001Ba is used, and therefore the movement of approximately 5D (plane pupil position (2D)+pupil position depth (1D)+light beam direction (2D)) is possible.

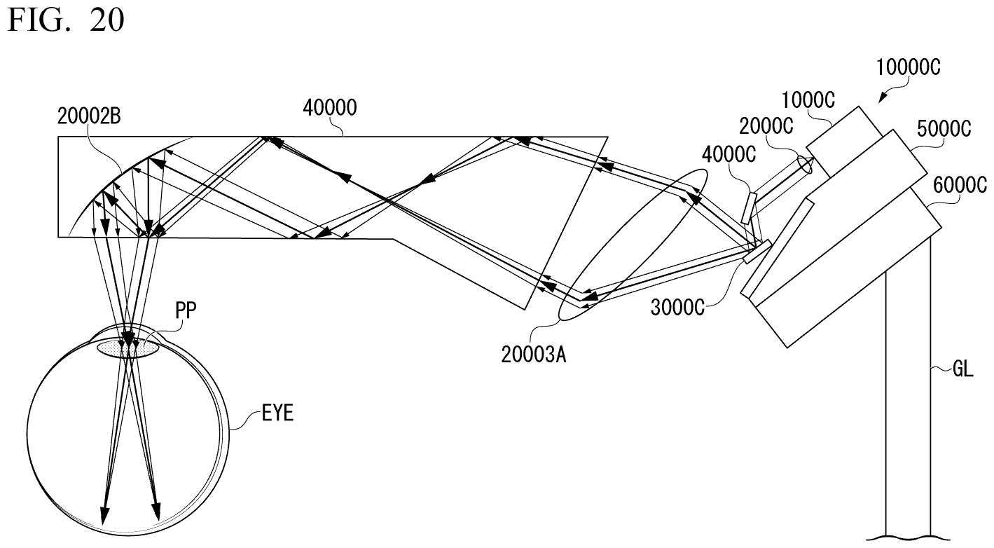

FIG. 20 shows a schematic diagram of AR glasses as another example of the retinal projection display device according to the present embodiment. In FIG. 20, featured parts are shown enlarged such that the features of the present invention are easier to understand. Constituent elements having the same reference signs are assumed to have similar configurations and description thereof will be omitted.

In the retinal projection display device of this example, a difference is that the translucent concave surface mirror 20003B corresponding to the translucent concave surface mirror (combiner) 20000B shown in FIG. 1 is embedded in the light guide plate 40000.

AR glasses 100001C shown in FIG. 20 include a projector module 10001C, a movement means 6001C configured to move the projector module 10001C, and a pupil position detection means configured to detect a pupil position (not shown), whereby the projector module 10001C can be moved by the movement means 6001C in correspondence with a change in the pupil position detected by the pupil position detection means.

The AR glasses 100001C shown in FIG. 20 further include a reflection mirror 4000C and optical systems 20003A and 20003B each having a Kepler-type telescope configuration. The translucent concave surface mirror 20003B is embedded in the light guide plate 40000. The light passing through the optical system 20003A and input to the light guide plate 40000 is guided by iterating total reflection on the light guide plate 40000 and reflected by the translucent concave surface mirror 20003B and converges on the vicinity of the pupil PP and then an image is drawn on the retina.

As a modified example of the AR glasses 100001C shown in FIG. 20, a configuration in which a diffraction element having a function similar to that of an input prism at an input position from the optical system of the Kepler-type telescope configuration of the light guide plate 40000 is provided and another diffraction element having a function similar to that of the translucent concave surface mirror 20003B at a position of an output from the light guide plate 40000 to the pupil is provided may be adopted.

As another modified example of the AR glasses 100001C shown in FIG. 20, a configuration in which an input prism is provided at a position of an input from the optical system of the Kepler-type telescope configuration of the light guide plate 40000 and a translucent mirror may be provided at a position of an output from the light guide plate 40000 to the pupil may be adopted.

As yet another modified example of the AR glasses 100001C shown in FIG. 20, a configuration in which an input prism is provided at a position of an input from the optical system of the Kepler-type telescope configuration of the light guide plate 40000, and a diffraction element is provided at a position of an output from the light guide plate 40000 to the pupil may be adopted.

The retinal projection display device of the present invention can be used as various display devices such as AR glasses, VR glasses, and an in-vehicle head-up display. Hereinafter, an example applied to the in-vehicle head-up display will be described.

### (Head-Up Display)

A head-up display (HUD) performs a display process by superimposing a projected image on a person's real-world field of vision to perceive both a real-world image and a projected image. For example, in the in-vehicle head-up display, a driver of a car can see an image in which driving assistance information is displayed further in front of the windshield in front thereof, in the form of superimposition with a background.

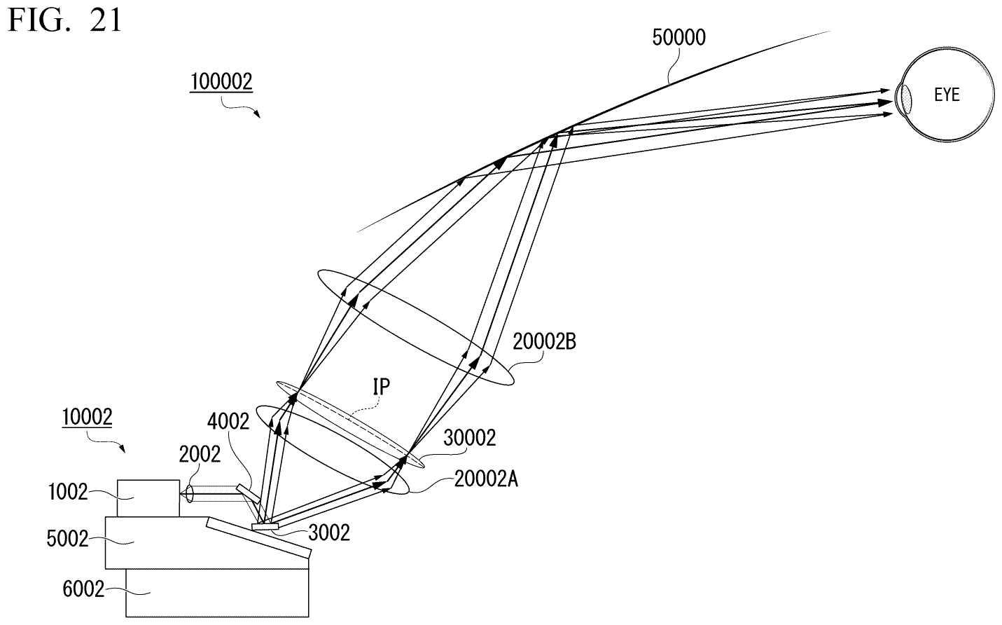

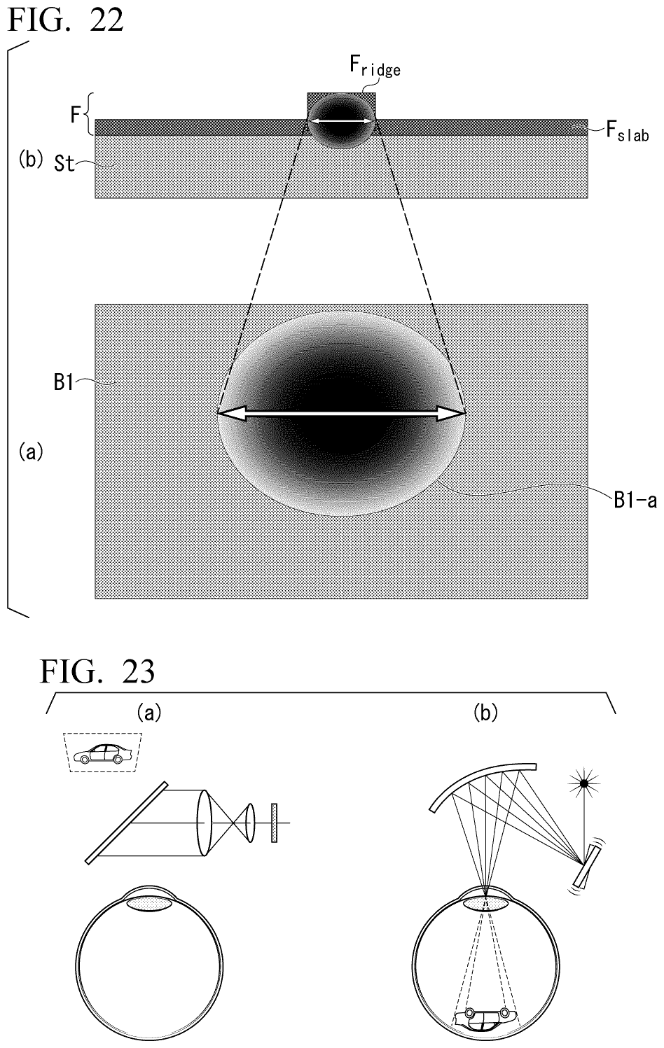

FIG. 21 shows a schematic diagram of an in-vehicle wearable head-up display using a retinal projection display device according to the above embodiment.

A head-up display 100002 shown in FIG. 21 corresponds to either the left or right eye and includes a projector module 10002, a movement means (for example, an XYZ triaxial actuator) 6002 configured to move the projector module 10002, and a pupil position detection means (not shown) configured to detect a pupil position, whereby the movement means 6002 can move the projector module 10002 in correspondence with a change in the pupil position detected by the pupil position detection means.

The projector module 10002 includes a laser module 1002 having a plurality of laser chips, a collimation lens 2002 configured to convert light from the laser module 1002 into parallel light beams, and an optical scanning device 3002 configured to change a direction of the light from the laser module 1002 to perform a scanning process. Because the laser module 1002, the collimation lens 2002, and the optical scanning device 3002 are fixed to a fixation stage 5002 via a support member or directly without the support member, their relative positions are uniform. Therefore, even when the projector module moves so that the light beam from the projection module can pass through the pupil in accordance with a change in the pupil position, relative positions of the laser module 1002, the collimation lens 2002, and the optical scanning device 3002 are fixed. Moreover, the projector module 10002 includes a reflection mirror 4002 configured to reflect light collimated by the collimation lens 2002 to the optical scanning device 3002.

The head-up display 100002 further includes an objective lens 20002A, an eyepiece lens 20002B, and a field lens 30002 as an optical system of a Kepler-type telescope configuration in which an intermediate imaging plane IP is located between the optical scanning device 3002 and the pupil.

In the head-up display 100002, an image of driving assistance information and the like from the projector module 10002 is reflected by a combiner (window shield glass) 50000 via the optical systems 20002A and 20002B having a Kepler-type telescope configuration and enters the eye of the driver of the car. The driver will see an image of driving assistance information and the like in a form superimposed on the background visible in front of the combiner 50000.

It is possible to provide another projector module in correspondence with each of the left and right eyes and independently perform an operation with another movement means (actuator). In this case, the movement means can be activated in correspondence with the movement of the head and each eye movement. Because the image can be displayed with separate projectors for the left and right eyes, it is possible to freely cause parallax in the image of the left and right eyes, and free stereo display is possible. Until now, because the same display is used to cause parallax in the left and right eyes with an optical system, the parallax is uniform and a distance of the virtual image is fixed.

By using a variable lens as the collimation lens or making a distance between the collimation lens and the laser module variable, it is possible to cause a virtual image distance due to parallax and a distance detected according to the focus adjustment of the eye to match each other. Thereby, it is possible to reduce discomfort.

The objective lens, field lens, and eyepiece lens are shared by the left and right eyes (and have a wide rectangular shape on the left and right), the projection module and the movement means (actuator) are separate for the left and right eyes.

Miniaturization can be reduced using a pancake lens for the eyepiece lens and the objective lens. A concave surface mirror may be used instead of a lens.

By shortening the focal length of the objective lens as compared with that of the eyepiece lens, it is possible to reduce the stroke of the actuator. A field of view (FOV) is smaller than a beam sweep angle of the MEMS mirror, but the FOV of the in-vehicle HUD is sufficient as about 10 degrees×5 degrees.

### REFERENCE SIGNS LIST

10-1, 10-2, 10-3 Mach-Zehnder-type optical waveguide
11, 12 Optical waveguide
30-1, 30-2, 30-3 Optical semiconductor element
50 Multiplexing portion
100 Light source unit
200 Optical modulation/output portion
1000, 1000Aa, 1000Ab, 1000Ac, 1000Ba, 1000Bb, 1000Bc, 1001A, 1001B, 1002 Laser Module
2000, 2000Aa, 2000Ab, 2000Ac, 2000Ba, 2000Bb, 2000Bc Collimation lens
3000, 3000Aa, 3000Ab, 3000Ac, 3000Ba, 3000Bb, 3000Bc Optical scanning device
6000, 6000A, 6000B, 6002 Movement means
10000, 10000A, 10000B, 10001A, 10001B, 10002 Projector module
100000, 100000A, 100000B, 100000C Retinal projection display device
100002 Head-up display

1. A projector module that is able to be used in a retinal projection display device and moved by a movement means, the projector module comprising:
a laser module having a plurality of laser chips;
a collimation lens configured to convert light from the laser module into parallel light beams; and
an optical scanning device configured to change a direction of the light from the collimation lens to perform a scanning process,
wherein relative positions of the laser module, the collimation lens, and the optical scanning device are fixed.

2. The projector module according to claim 1,
wherein the laser module includes a planer lightwave circuit configured to multiplex light output from the plurality of laser chips,
wherein the light output from the plurality of laser chips is modulated with a driving current,
wherein the collimation lens collimates the light multiplexed by the planer lightwave circuit and the optical scanning device performs the scanning process with the collimated light.

3. The projector module according to claim 1,
wherein the laser module includes
a plurality of Mach-Zehnder-type optical waveguides to which the light output from the plurality of laser chips is input; and
a multiplexing portion configured to multiplex modulated light from the plurality of Mach-Zehnder-type optical waveguides, and
wherein the collimation lens collimates the light multiplexed by the multiplexing portion and the optical scanning device performs the scanning process with the collimated light.

4. The projector module according to claim 1,
wherein a plurality of collimation lenses configured to convert light from each of the plurality of laser chips into parallel light beams are provided as the collimation lens, the number of collimation lenses being the same as the number of laser chips,
wherein the projector module comprises a dichroic mirror configured to multiplex the light collimated by the plurality of collimation lenses, and
wherein the optical scanning device changes a direction of light multiplexed by the dichroic mirror to perform the scanning process.

5. The projector module according to claim 1,
wherein a plurality of collimation lenses configured to convert light from each of the plurality of laser chips into parallel light beams are provided as the collimation lens, the number of collimation lenses being the same as the number of laser chips, and
wherein the light collimated by the plurality of collimation lenses is input to the optical scanning device at different angles and the optical scanning device changes a direction of light to perform the scanning process.

6. The projector module according to claim 1, wherein the Mach-Zehnder-type optical waveguide is made by convexly processing a lithium niobate film.

7. The projector module according to claim 1, wherein the optical scanning device is a microelectromechanical systems (MEMS) mirror device.

8. A retinal projection display device comprising:
the projector module according to claim 1;
a movement means configured to move the projector module; and
a pupil position detection means configured to detect a pupil position,
wherein the movement means moves the projector module in correspondence with a change in the pupil position detected by the pupil position detection means.

9. The retinal projection display device according to claim 8, wherein the movement means is a two-dimensional stage using a linear actuator.

10. (canceled)

11. The retinal projection display device according to claim 8, wherein the movement means is an actuator using a spherical motor.

12. The retinal projection display device according to claim 8, wherein the movement means is a voice coil motor.

13. (canceled)

14. The retinal projection display device according to claim 8, comprising an optical system of a Kepler-type telescope configuration in which an intermediate imaging plane is located between the optical scanning device and the pupil.

15. (canceled)

16. The retinal projection display device according to claim 14, comprising a field lens configured to adjust a light beam direction in the vicinity of the intermediate imaging plane.

17. The retinal projection display device according to claim 14, comprising a light guide plate between an optical system of the Kepler-type telescope configuration and a pupil,
wherein an image is projected onto a retina through the light guide plate.

18. The retinal projection display device according to claim 17, comprising:
a refraction element at a position of an input from the optical system of the Kepler-type telescope configuration of the light guide plate; and
another refraction element at a position of an output from the light guide plate to the pupil.

19. The retinal projection display device according to claim 17, comprising:
an input prism at a position of an input from the optical system of the Kepler-type telescope configuration of the light guide plate; and
a translucent mirror at a position of an output from the light guide plate to the pupil.

20. The retinal projection display device according to claim 17, comprising:
an input prism at a position of an input from the optical system of the Kepler-type telescope configuration of the light guide plate; and
a refraction element at a position of an output from the light guide plate to the pupil.

21. A head-up display comprising:
the retinal projection display device according to claim 8 for use in each of left and right eyes,
wherein the movement means moves the projector module in correspondence with a change in a pupil position of the left or right eye detected by the pupil position detection means in correspondence with the pupil position of the left or right eye detected using the pupil position detection means.

22. The head-up display according to claim 21, wherein the collimation lens of the projector module is a variable lens or a distance between the collimation lens and the laser module in the projector module is variable.

23. The head-up display according to claim 21, wherein the head-up display is for automotive use.
